(19) United States
(12) Patent Application Publication
(10) Pub. No.: US 2020/0380568 A1
(43) Pub. Date: Dec. 3, 2020

(54) STORAGE SYSTEM

(71) Applicant: Carousel Media Group, Inc., Burnsville, MN (US)

(72) Inventors: Robert Vernon Thamert, Lakeville, MN (US); Donald Leonard Riesterer, Milton, WI (US); Paul William Buenger, Eau Claire, WI (US); Michael John Buchmann, Chippewa Falls, WI (US); James D. Young, Eau Claire, WI (US); Charles Michael Betz, Eau Claire, WI (US); Brian Mark Hostetler, Chippewa Falls, WI (US)

(21) Appl. No.: 16/773,622

(22) Filed: Jan. 27, 2020

Related U.S. Application Data
(63) Continuation of application No. 14/796,411, filed on Jul. 10, 2015, now abandoned.

(51) Int. Cl. G06Q 30/02; H04N 21/81; H04N 21/2743; H04N 21/414; A47F 7/14

(52) U.S. Cl. CPC G06Q 30/0277; H04N 21/812; G06Q 30/0251; A47F 7/146; H04N 21/41415; A47F 7/145; H04N 21/2743

(57) ABSTRACT

A storage system includes a storage assembly for storing objects therein and an output assembly for displaying contents. In certain examples, the storage assembly defines one or more compartments configured to store movable objects therein, and the output assembly is secured to the storage assembly. The output assembly includes one or more display device assemblies configured to display contents, and a control device assembly configured to receive the contents and display the contents through the one or more display device assemblies.

### CROSS REFERENCE TO RELATED APPLICATION

This application claims priority to U.S. patent application Ser. No. 14/796,411, filed on Jul. 10, 2015, the disclosure of which is hereby incorporated by reference in its entirety.

### BACKGROUND

Small storage units are used to store or display various objects. For example, literature racks or holders are used for storing literature, publications, flyers, brochures, magazines, and printed materials of a variety of widths. Storage units are also used to store or display other objects, such as audio and video storage media (e.g., digital optical discs). Such storage units can be designed in various types, such as countertop displays, wall mounted holders, floor standing poster stands, and rotating literature displays. The storage units can be placed in various locations. In certain examples, the storage units are disposed on, or adjacent to, tables, counters, and desks.

The storage units can be installed in public spaces or high traffic areas, such as office receptions, lobbies, entryways, waiting rooms, and showrooms, and presented to people so that people can easily access the materials, such as magazines and brochures. In certain examples, the storage units are also used as advertising media that attract people's attention and present advertisements to them.

### SUMMARY

In general terms, this disclosure is directed to a storage system. In one possible configuration and by non-limiting example, the storage system includes a storage assembly for storing objects therein and an output assembly for displaying contents. Various aspects are described in this disclosure, which include, but are not limited to, the following aspects.

One aspect is a storage system. The system includes a storage assembly and an output assembly. The storage assembly defines one or more compartments configured to store movable objects therein. The output assembly is secured to the storage assembly. The output assembly includes one or more display device assemblies configured to display at least one content, and a control device assembly configured to receive the at least one content and display the at least one content through the one or more display device assemblies.

Another aspect is a method for presenting at least one content. The method includes receiving at least one content from a content provider, and uploading the at least one content to a storage system. The storage system includes a storage assembly and an output assembly. The storage assembly defines one or more compartments configured to store movable objects therein. The output assembly is secured to the storage assembly. The output assembly includes one or more display device assemblies configured to display at least one content, and a control device assembly configured to receive the at least one content and display the at least one content through the one or more display device assemblies.

Yet another aspect is a system. The system includes an output assembly. The output assembly includes at least one processing device, a content output device configured for communication with one or more display devices, and at least one computer readable data storage media storing software instructions that, when executed by the at least one processing device, cause the at least one processing device to: receive at least one content item; transmit the at least one content item to one or more display devices through the content output device; and generate feedback data including status information.

### BRIEF DESCRIPTION OF THE DRAWINGS

FIG. 1 illustrates an exemplary embodiment of a system for operating one or more storage units with advertising display devices.

FIG. 2 is a perspective view of an example advertisement deliverable storage system.

FIG. 3 is a perspective expanded view of the advertisement deliverable storage system of FIG. 2.

FIG. 4 is a perspective view of an example storage body.

FIG. 5 is a cross-sectional view of the storage body of FIG. 4.

FIG. 5A is an enlarged view of the storage body of FIG. 5.

FIG. 6 is a bottom view of the storage body of FIG. 4.

FIG. 7A shows a front view of an example first compartment divider panel.

FIG. 7B is a side view of the first compartment divider panel of FIG. 7A.

FIG. 8 is a perspective view of an example compartment spacer.

FIG. 9 is a side view of the compartment spacer of FIG. 8.

FIG. 9A is an enlarged view of the compartment spacer of FIG. 9.

FIG. 10 illustrates an example second compartment divider panel.

FIG. 11 is a top view of the advertisement deliverable storage system, illustrating an example arrangement of the first compartment divider panels, the compartment spacer, and the second compartment divider panels within the storage body.

FIG. 12 is a perspective view of an example control device housing.

FIG. 13 is a top view of the control device housing of FIG. 12.

FIG. 14 is a bottom view of the control device housing of FIG. 12.

FIG. 15 is a cross-sectional view of the control device housing of FIG. 12.

FIG. 16 is a cross-sectional view of the control device housing of FIG. 12.

FIG. 17 is a perspective expanded view of an example first display device assembly.

FIG. 18 is a perspective view of an example display screen frame of the first display device assembly.

FIG. 19 is a rear view of the display screen frame of FIG. 18.

FIG. 20 is a perspective expanded view of an example second display device assembly.

FIG. 21 is a perspective view of an example display screen frame of the second display device assembly.

FIG. 22 is a rear view of the display screen frame of FIG. 21.

FIG. 23 illustrates an example control device.

FIG. 24 illustrates another example of the control device.

FIG. 25 illustrates an exemplary architecture of a control module.

FIG. 26 illustrates yet another example of the control device.

FIG. 27 illustrates a system for operating the advertisement deliverable storage system.

FIG. 28 is a flowchart illustrating an example method for operating the advertisement deliverable storage system.

FIG. 29 illustrates an example method of operating the advertisement deliverable storage system.

FIG. 30 illustrates an example server database structure that is implemented in an advertisement management server computing device.

FIG. 31 illustrates an example control device database structure that is implemented in a control device of an advertisement deliverable storage system.

FIG. 32 is a schematic perspective view of another example advertisement deliverable storage system.

FIG. 33 schematically illustrates an example first storage unit

FIG. 34 schematically illustrates an example second storage unit.

FIG. 35 is a schematic expanded view of an example advertisement output assembly.

FIG. 36 is a schematic front perspective view of an example advertisement delivery system.

FIG. 37 is a schematic rear perspective view of the advertisement delivery system of FIG. 36.

FIG. 38 illustrates an exemplary architecture of a computing device that can be used to implement aspects of the present disclosure.

FIG. 39 illustrates an example setup interface displaying various pieces of information about a storage system and a server computing device.

FIG. 40 illustrates the setup interface displaying an example menu screen for setup.

FIG. 41 illustrates the setup interface displaying an example database setup screen.

FIG. 42 illustrates the setup interface displaying information about the storage system.

FIG. 43 illustrates the setup interface displaying an example screen for a network setup.

FIG. 44 illustrates the setup interface displaying an example self-testing process.

FIG. 45 illustrates the setup interface displaying an example screen for a date/time setup.

### DETAILED DESCRIPTION

Various embodiments will be described in detail with reference to the drawings, wherein like reference numerals represent like parts and assemblies throughout the several views.

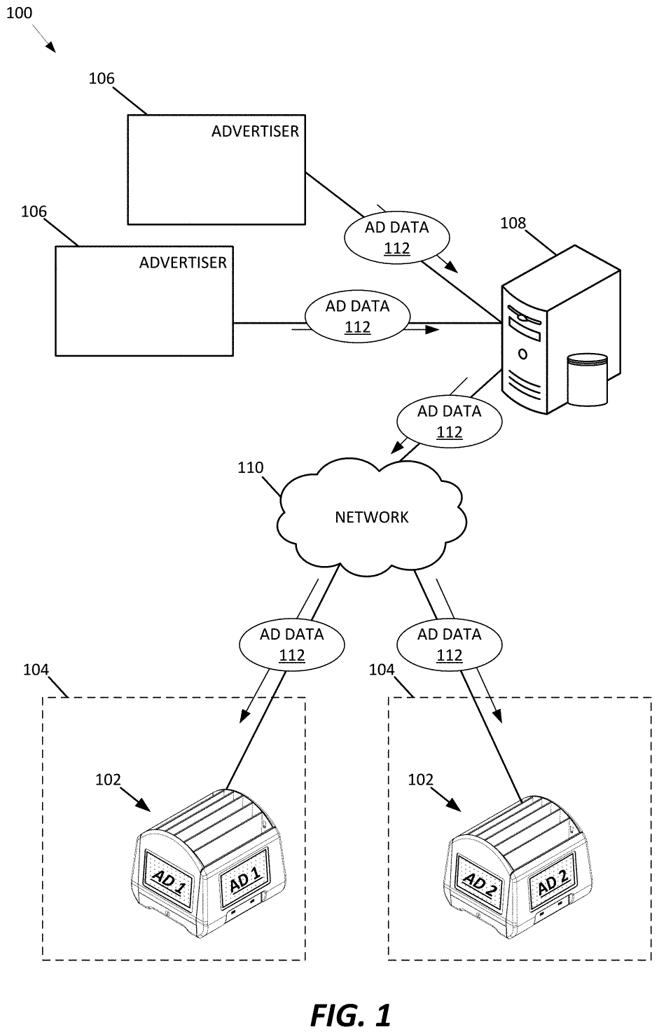

FIG. 1 illustrates an exemplary embodiment of a system 100 for operating one or more storage units with advertising display devices. The system 100 includes an advertisement deliverable storage system 102, which is used in a consumer interaction area 104, an advertiser 106, an advertisement management server computing device 108, and a data communication network 110. Also shown is advertising data 112.

The advertisement deliverable storage system 102 is a storage system configured to store various tangible, movable objects and run advertisements. In some embodiments, the advertisement deliverable storage system 102 is configured as a literature storage unit. For example, the advertisement deliverable storage system 102 is a literature rack for storing printed materials of various types, such as books, magazines, brochures, flyers, and other publications. In other embodiments, the advertisement deliverable storage system 102 is configured to store other objects.

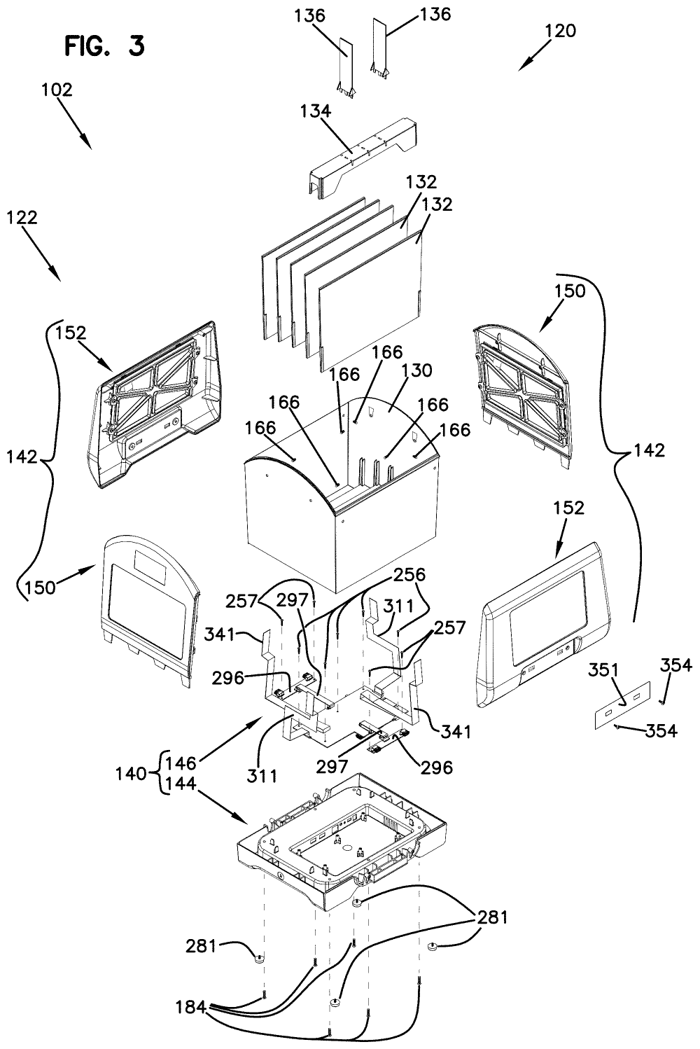

As described herein, the advertisement deliverable storage system 102 is configured to output one or more advertisements through output devices (e.g., display devices) associated with the storage system 102. For example, the advertisement deliverable storage system 102 includes one or more display devices (e.g., display device assemblies 150 and 152 in FIG. 3) to display one or more advertisements thereon.

In some embodiments, the advertisement deliverable storage system 102 transmits information to, and receives information from, the advertisement management server computing device 108. For example, the advertisement deliverable storage system 102 receives advertising data 112 that include advertisement content items and advertising campaign information. Based on the advertising campaign information, the advertisement deliverable storage system 102 operates to run the advertisement content items through the display devices of the system 102. Further, the advertisement deliverable storage system 102 transmits data, such as advertising status information, to the advertisement management server computing device 108.

The consumer interaction area 104 indicates a place in which the advertisement deliverable storage system 102 is located to provide means for storing and/or displaying various tangible objects, such as printed materials, and devices for presenting advertisements. In some embodiments, the consumer interaction area 104 can be an area where people typically visit or gather. Examples of the consumer interaction area 104 include office receptions, lobbies, entryways, waiting rooms, and showrooms. People who are present at the consumer interaction area 104 can access the materials, such as magazines and brochures, stored in the advertisement deliverable storage system 102, and recognize the advertisements displayed by the advertisement deliverable storage system 102.

The advertiser 106 provides the advertising data 112 to the advertisement management server computing device 108. The advertiser 106 can be a person, group, organization, or company that promotes a product, service, business, candidate, cause, and/or other objectives in various marketing campaigns. Examples of the advertiser 106 include advertising professionals, agencies, and media researchers. For example, the advertiser 106 is organized to manage an advertising campaign. In the advertising campaign, the advertiser 106 can perform a coordinated series of steps that include promotion of a product and/or service through one or more advertisement deliverable storage systems 102 in one or more consumer interaction areas 104. In some examples, the advertising campaign can include a variety of different advertisements that are presented through one or more advertisement deliverable storage system 102 across a specific time frame. In other examples, the advertising campaign is configured to repeat the same advertisement across a specific time frame. The advertising campaign can be identically delivered in at least some of the consumer interaction areas 104. In other embodiments, the advertising campaign can be presented differently across different consumer interaction areas 104.

The advertisement management server computing device 108 interacts with the advertisement deliverable storage systems 102 and provides advertisement content items and advertising campaign information to the advertisement deliverable storage systems 102. In some embodiments, the advertisement management server computing device 108 provides an interface (e.g., a web portal or dashboard) that allows the advertisers 106 to identify the advertisement deliverable storage systems 102, track status of advertisement run at the advertisement deliverable storage systems 102, and instruct various operations of the advertisement deliverable storage system 102. In some embodiments, the advertiser 106 interacts with the advertisement deliverable storage system 102 on personal computers or other computing devices, such as desktop computers, laptops, smartphones, tablets and other hand-held devices.

The network 110 communicates digital data between one or more computing devices, such as between the advertisement deliverable storage systems 102 and the advertisement management server computing device 108. Examples of the network 110 include a local area network and a wide area network, such as the Internet.

In some embodiments, the network 110 includes a wireless communication system, a wired communication system, or a combination of wireless and wired communication systems. A wired communication system can transmit data using electrical or optical signals in various possible embodiments. Wireless communication systems typically transmit signals via electromagnetic waves, such as in the form of optical signals or radio frequency (RF) signals. A wireless communication system typically includes an optical or RF transmitter for transmitting optical or RF signals, and an optical or RF receiver for receiving optical or RF signals. Examples of wireless communication systems include Wi-Fi communication devices (such as utilizing wireless routers or wireless access points), cellular communication devices (such as utilizing one or more cellular base stations), and other wireless communication devices.

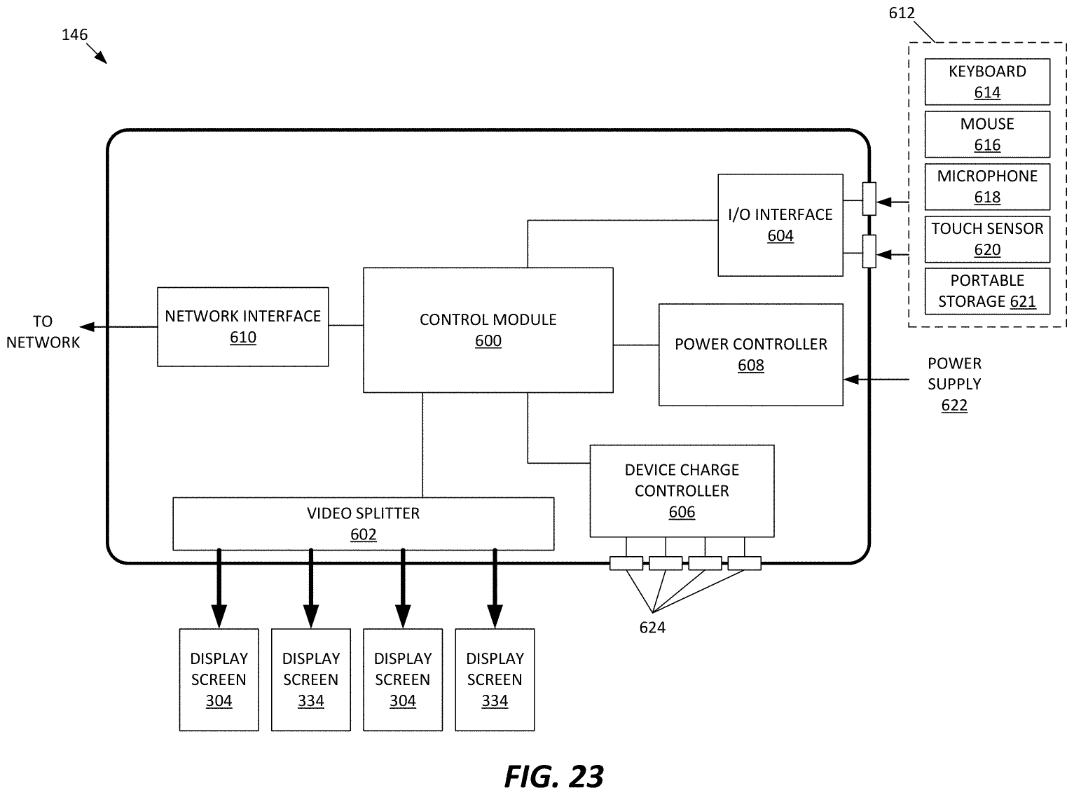

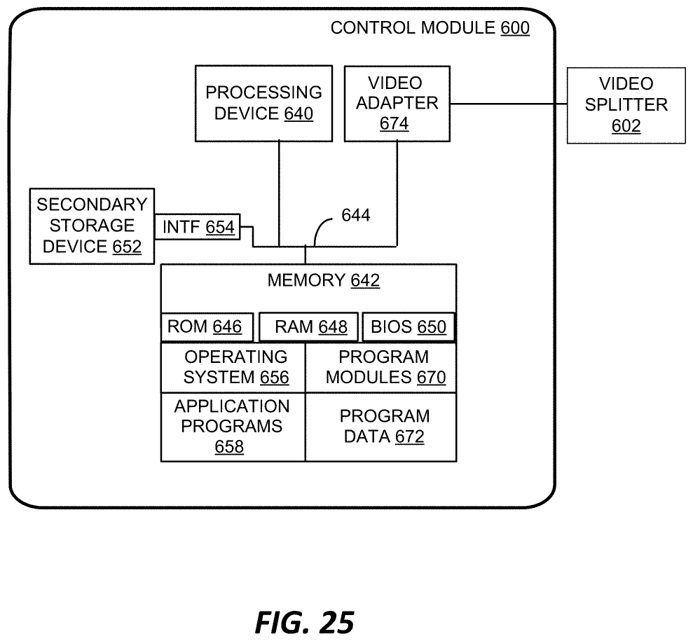

In some embodiments, the system 100 does not employ data communications through the network 110. For example, an operator or business operating the advertisement management server computing device 108 receives the advertising data 112 from the advertiser 106, and uploads the advertising data 112 to a memory (e.g., a system memory 642 in FIG. 25) of the advertisement deliverable storage system 102 directly. In some embodiments, the advertising data 112 can be uploaded to the advertisement deliverable storage system 102 before distributing the advertisement deliverable storage system 102 to the consumer interaction area 104. In other embodiments, an operator, or any other person who has the advertising data 112, can visit the consumer interaction area 104 or other places where the advertisement deliverable storage system 102 is located, and manually transfer the advertising data 112 to the advertisement deliverable storage system 102, using an input device (e.g., input devices 612 through an input/output interface 604 of the advertisement deliverable storage system 102, as shown in FIG. 23). In the meantime, the operator or business can store the advertising data 112 in the advertisement management server computing device 108 for storage and other management purposes. In yet other embodiments, the advertiser 106 (or a person working for the advertiser 106) can directly upload the advertising data 112 to the advertisement deliverable storage system 102, using a portable storage device storing the advertising data 112. For example, the advertiser 106 can provide the advertising data 112 (including advertising contents such as videos and images, and advertising campaign details) to a person by delivering a portable storage device storing the advertising data 112 or by transmitting the advertising data 112 to the person through an email system or a file transfer system. The person who has received the advertising data 112 can then enter the advertising data 112 to the storage system 102.

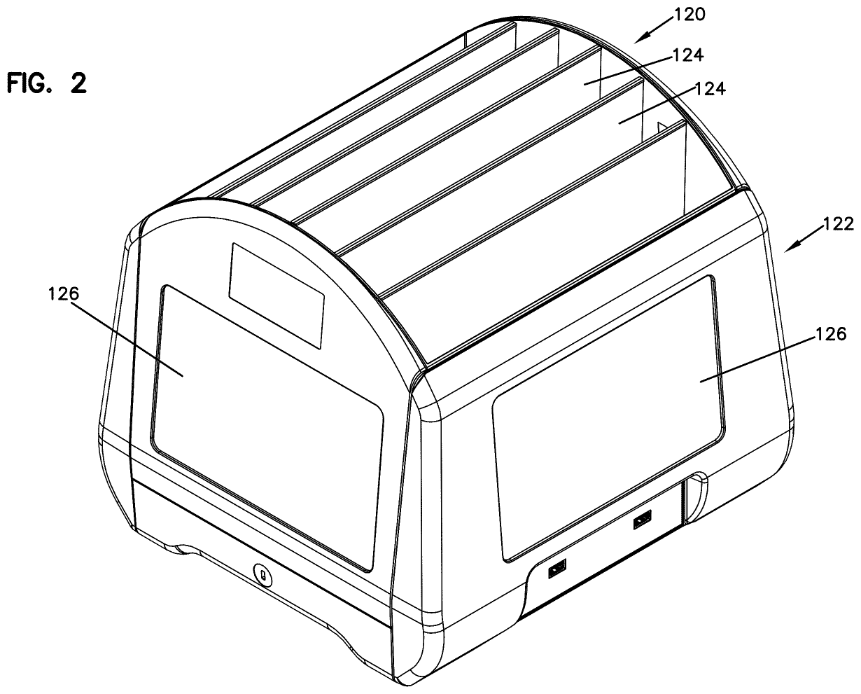

Referring to FIGS. 2-22, an exemplary embodiment of the advertisement deliverable storage system 102 is described.

FIG. 2 is a perspective view of an example advertisement deliverable storage system 102. In some embodiments, the advertisement deliverable storage system 102 includes a storage assembly 120 and an advertisement output assembly 122.

In the illustrated example, the advertisement deliverable storage system 102 is configured as a countertop storage unit for storing printed materials, such as magazines and brochures. In other embodiments, the advertisement deliverable storage system 102 is designed to store other movable objects and placed in other locations, such as on a floor or against a wall.

The storage assembly 120 defines one or more compartments 124 configured to store printed materials therein. As described herein, the storage assembly 120 includes one or more dividing panels (e.g., compartment divider panels 132 and 136 in FIG. 3) configured to define the compartments 124.

The advertisement output assembly 122 is configured to display one or more advertising contents through one or more display devices 126. In some embodiments, the advertisement output assembly 122 is secured to the storage assembly 120. In the illustrated example, the advertisement output assembly 122 is fixed on lateral sides of the storage assembly 120 while a top side of the storage assemblyl20 is open and exposes the compartments 124 to receive the printed materials.

FIG. 3 is a perspective expanded view of the advertisement deliverable storage system 102 of FIG. 2. As described above, the advertisement deliverable storage system 102 includes the storage assembly 120 and the advertisement output assembly 122.

In some embodiments, the storage assembly 120 includes a storage body 130, at least one first compartment divider panel 132, at least one compartment spacer 134, and at least one second compartment divider panel 136.

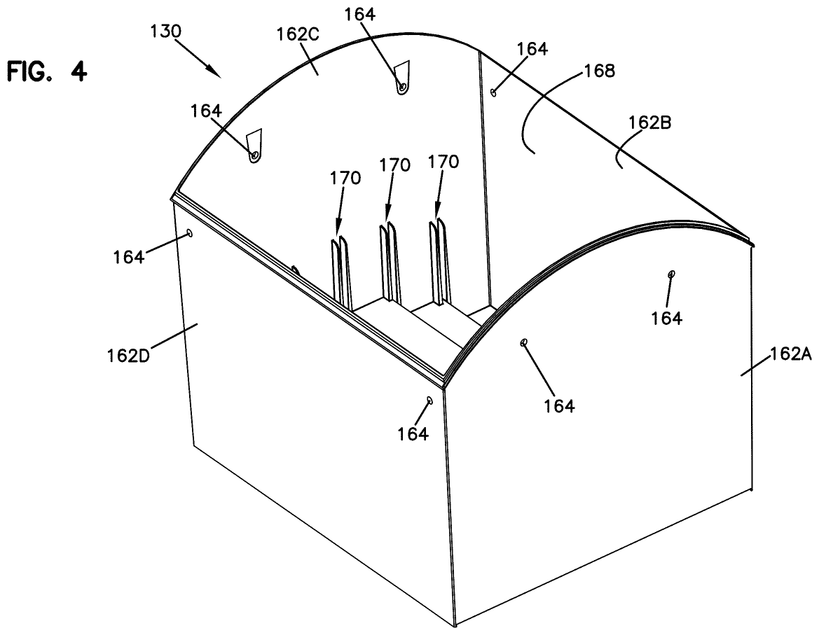

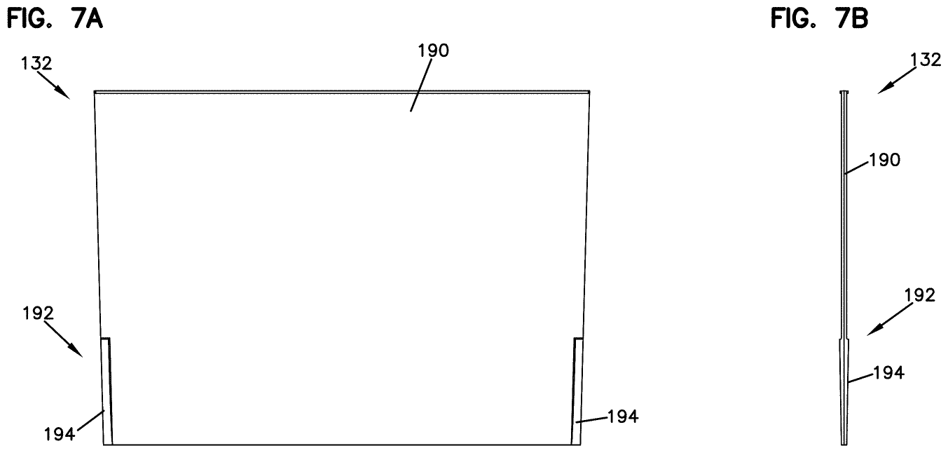

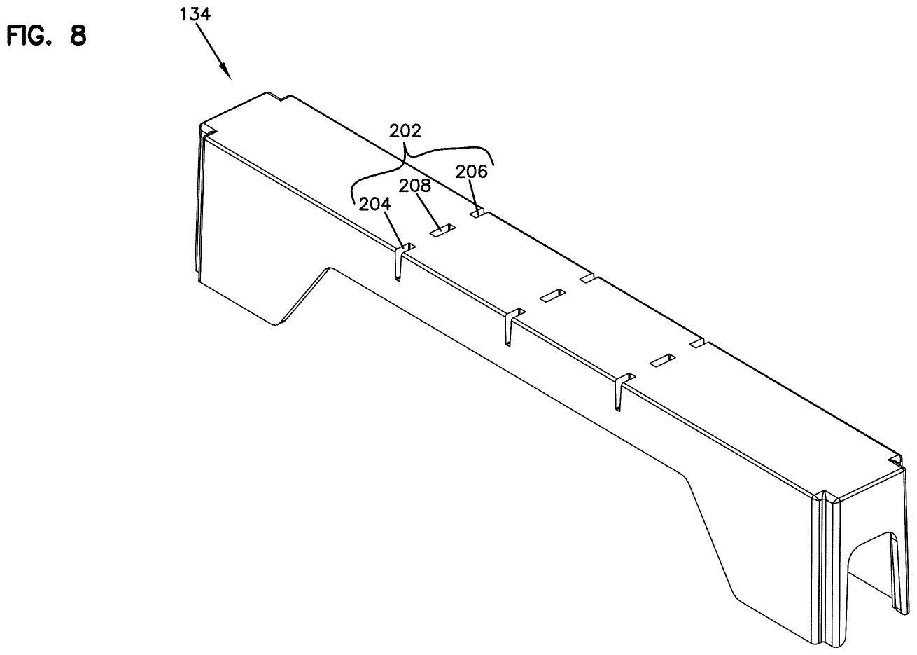

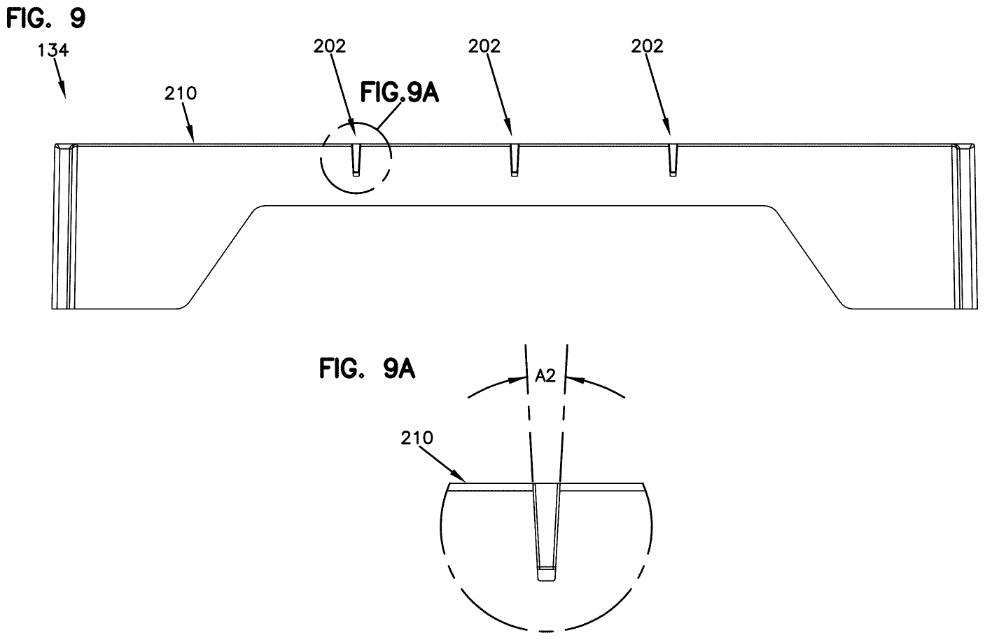

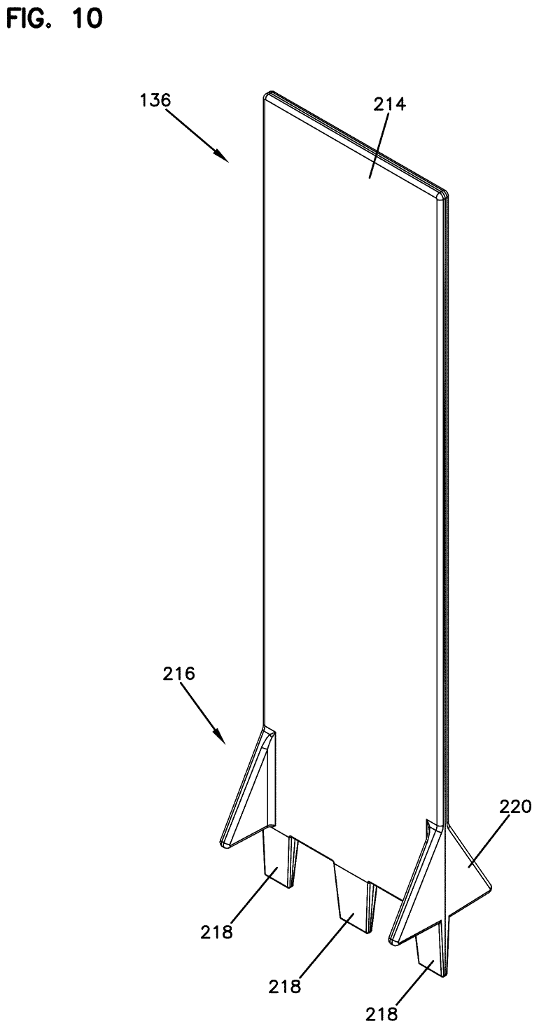

An example of the storage body 130 is described and illustrated with reference to FIGS. 4-6. An example of the first compartment divider panel 132 is described and illustrated with reference to FIGS.7A and 7B. An example of the compartment spacer 134 is described and illustrated with reference to FIGS. 8-9. An example of the second compartment divider panel 136 is described and illustrated with reference to FIG. 10.

In some embodiments, the advertisement output assembly 122 includes a control device assembly 140 and a display device assembly 142. Some embodiments of the control device assembly 140 include a control device housing 144 and a control device 146. Some embodiments of the display device assembly 142 include at least one first display device assembly 150 and at least one second display device assembly 152.

In the illustrated example, the display device assembly 142 includes two oppositely disposed first display device assemblies 150 and two oppositely disposed second display device assemblies 152. In some embodiments, at least one of the display device assemblies 150 and 152 is replaced by a blank frame or dummy frame to make one, two, or three-sided display device system. In some embodiments, the blank frame can be made similarly to the display device assembly 150 and 152 by replacing a display screen therein (e.g., display screens 304 and 334) with a blank plate.

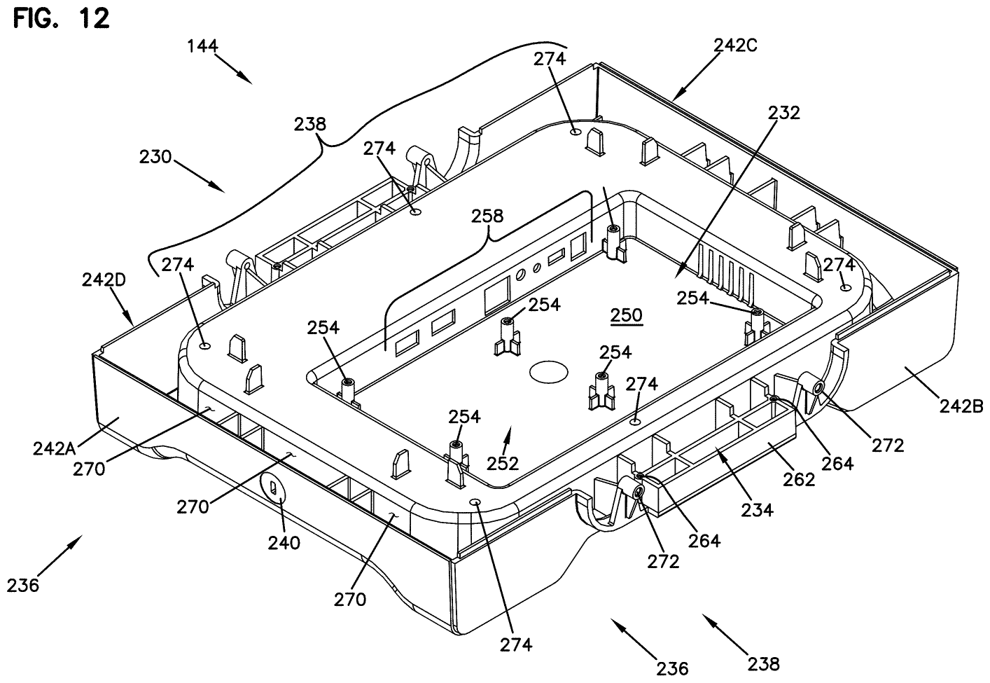

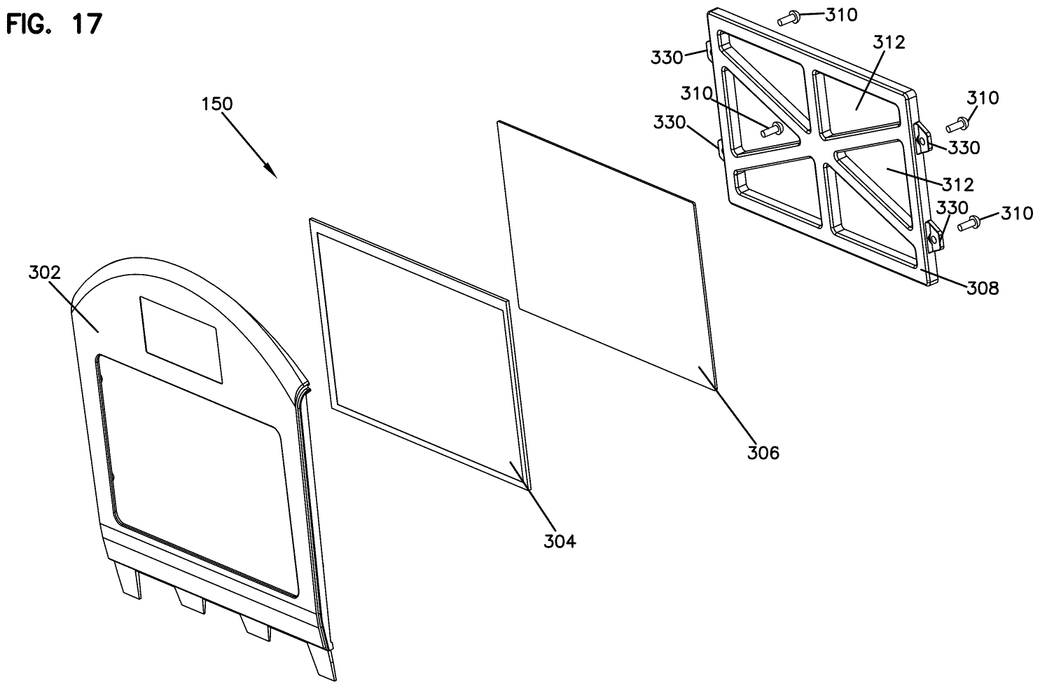

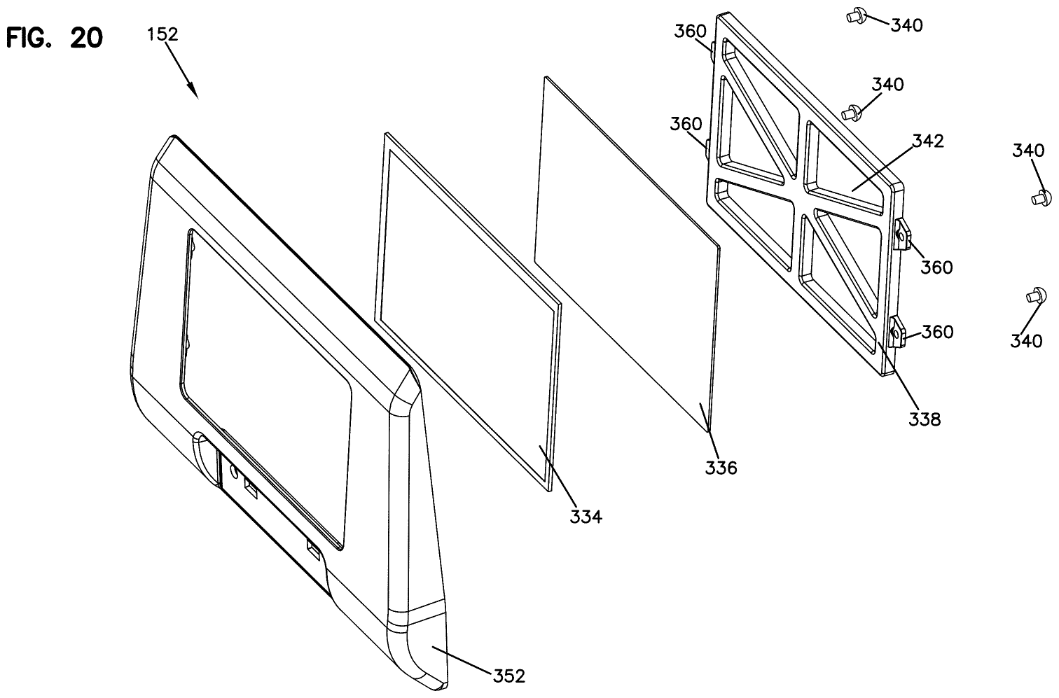

An example of the control device housing 144 is described and illustrated with reference to FIGS. 12-16. An example of the control device 146 is described and illustrated with reference to FIGS. 23-26. An example of the first display device assembly 150 is described and illustrated with reference to FIGS. 17-19. An example of the second display device assembly 152 is described and illustrated with reference to FIGS. 20-22.

Referring to FIGS. 4-6, an example storage body 130 is described.

FIG. 4 is a perspective view of an example storage body 130. In some embodiments, the storage body 130 has a bottom portion 160 and a plurality of side walls 162.

In the illustrated example, the storage body 130 has four side walls, such as a first side wall 162A, a second side wall 162B, a third side wall 162C opposite to the first side wall 162A, and a fourth side wall 162D opposite to the second side wall 162B.

The side walls 162 are configured to secure the display device assembly 142 thereto. As described herein, the first display device assemblies 150 are configured to be attached to the first and third side walls 162A and 162C, and the second display device assemblies 152 are configured to be attached to the second and fourth side walls 162B and 162D. In some embodiments, the side walls 162 include fastening holes 164 that receive fasteners 166 (FIG. 3), such as screws, from the interior of the storage body 130 to secure the display device assembly 142.

The storage body 130 defines a cavity 168 configured to provide a space for receiving printed materials. The cavity 168 can be divided into a plurality of compartments 124 (FIG. 2) by various dividing means (such as the first compartment divider panel 132, at least one compartment spacer 134, and at least one second compartment divider panel 136), as described below. Examples of such dividing means are illustrated and described with reference to FIGS. 7A, 7B, 8, 9, 9A, 10 and 11.

The storage body 130 can provide one or more compartment divider panel guides 170. In the illustrated example, the compartment divider panel guides 170 are symmetrically provided the inner surfaces of the first and third side walls 162A and 162C.

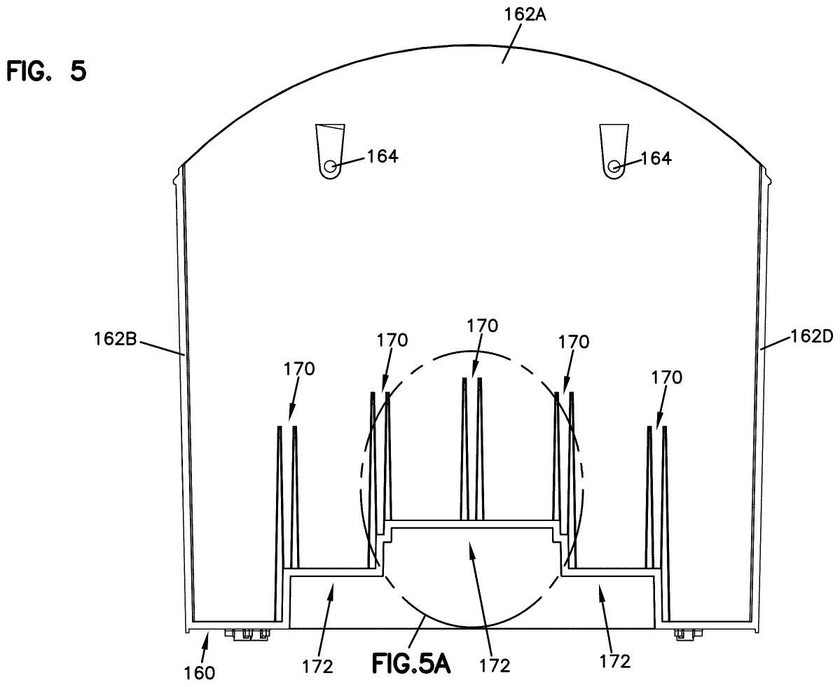

FIG. 5 is a cross-sectional view of the storage body 130 of FIG. 4, and FIG. 5A is an enlarged view of the storage body 130 of FIG. 5.

As illustrated, the bottom portion 160 of the storage body 130 is provided with a stepped floor portion 172 configured to provide different depths of the compartments 124 from the top portion of the storage body 130. The stepped floor portion 172 is configured to store the printed materials of different sizes while allowing easy access to them from the top of the storage body 130.

In some embodiments, the compartment divider panel guide 170 includes a pair of ridges 174 (e.g., a first ridge 174A and a second ridge 174B) to define a slot 176 therebetween. In some examples, the first and second ridges 174A and 174B extend perpendicularly from an inner surface 178 of the bottom portion 160. The first and second ridges 174A and 174B are configured such that a width of the slot 176 between the first and second ridges 174A and 174B gradually increases from the inner surface 178 of the bottom portion 160. In some embodiments, an angle (A) defined at the slot 176 ranges from about 1 degree to about 5 degrees. In other embodiments, the angle (A) of the slot 176 is about 2 degrees.

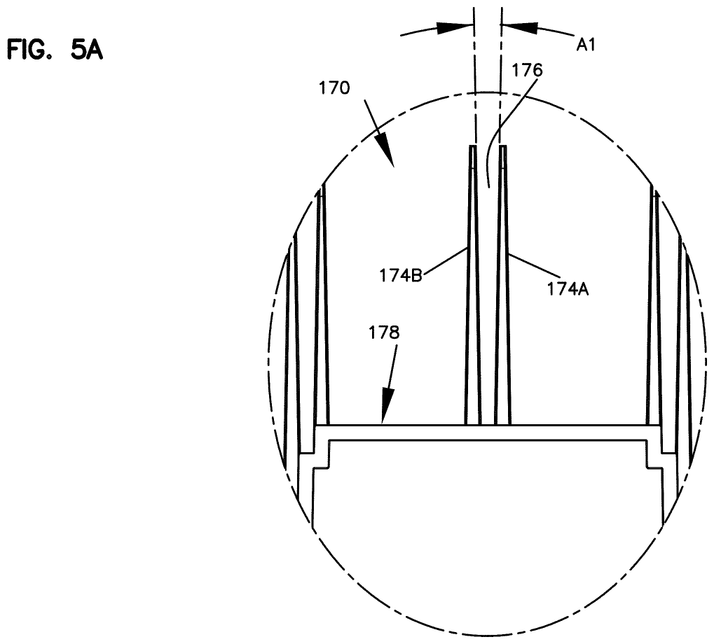

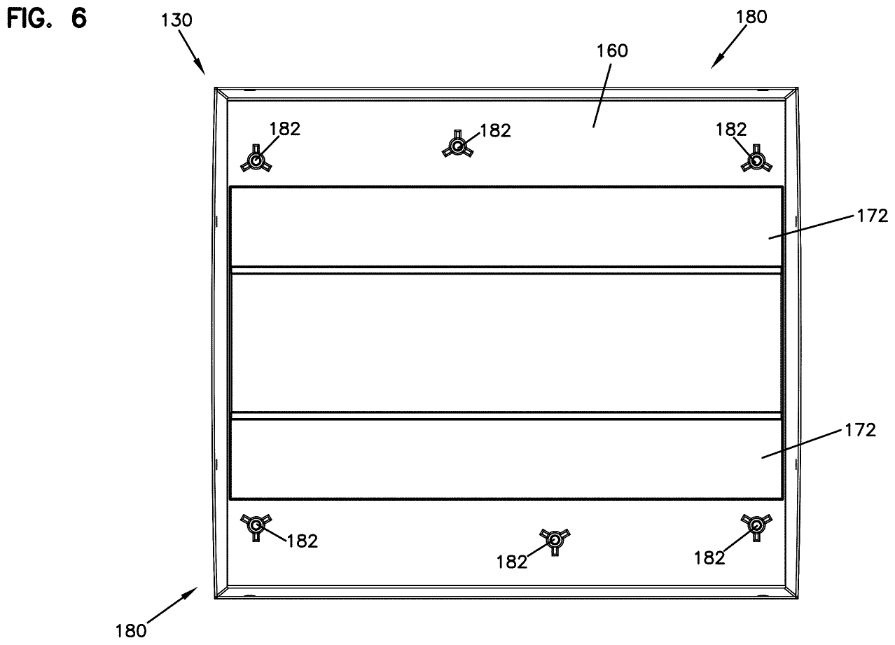

FIG. 6 is a bottom view of the storage body 130 of FIG. 4. As illustrated, the storage body 130 includes a body mounting structure 180. In some embodiments, the body mounting structure 180 is configured to secure the storage body 130 to the control device housing 144, which also functions as a base of the advertisement deliverable storage system 102. In some embodiments, the body mounting structure 180 includes one or more fastener holes 182 for receiving fasteners 184 (FIG. 3), such as screws, from the exterior of the control device housing 144 to couple the storage body 130 to the control device housing 144.

Referring to FIGS. 7A, 7B, 8, 9, 9A, 10, and 11, example devices are described for dividing the cavity 168 of the storage body 130 into a plurality of compartments 124.

FIG. 7A shows a front view of an example of the first compartment divider panel 132, and FIG. 7B is a side view of the first compartment divider panel 132 of FIG. 7A. In some embodiments, the first compartment divider panel 132 includes a dividing plate 190 and a panel mounting structure 192.

The dividing plate 190 is arranged transversely within the cavity 168 of the storage body 130 to divide the cavity 168 into two or more spaces.

The panel mounting structure 192 is used to mount the first compartment divider panel 132 within the cavity 168 of the storage body 130. In some embodiments, the panel mounting structure 192 includes a pair of wedge portions 194 that are configured to correspondingly engage the compartment divider panel guide 170 (e.g., the pair of ridges 174). For example, as the first compartment divider panel 132 is inserted into the storage body 130, the wedge portions 194 of the first compartment divider panel 132 slide into the slots 176 defined by the ridges 174 at the first and third side walls 162A and 162C of the storage body 130. As a result, the first compartment divider panel 132 divides the cavity 168 between the second and fourth side walls 162B and 162D of the storage body 130.

FIGS. 8, 9, and 9A illustrate an example of the compartment spacer 134. In particular, FIG. 8 is a perspective view of an example compartment spacer 134, FIG. 9 is a side view of the compartment spacer 134 of FIG. 8, and FIG. 9A is an enlarged view of the compartment spacer of FIG. 9.

The compartment spacer 134 is configured to be disposed between adjacent first compartment divider panels 132 within the storage body 130 in order to reduce a depth of a compartment 124 defined by the adjacent first compartment divider panels 132. The compartment 124 including the compartment spacer 134 is shallower than the same compartment 124 without the compartment spacer 134 and can thus store printed materials having smaller size. For example, the compartment spacer 134 can be used to make a compartment 124 available for storing brochures while the compartment 124 is used to receive magazines, which are larger than the brochures, without the compartment spacer 134.

In some embodiments, the compartment spacer 134 includes one or more compartment divider panel mounting structures 202 configured to uphold the second compartment divider panels 136 thereon. In the illustrated example, the compartment divider panel mounting structure 202 includes three slots aligned in a direction perpendicular to a length of the compartment spacer 134. The compartment divider panel mounting structure 202 can include opposing edge slots 204 and 206 and a middle slot 208 therebetween. These three slots 204, 206 and 208 are configured to receive tabs of the second compartment divider panel 136 to support the second compartment divider panel 136 on the compartment spacer 134. In some embodiments, the slots 204, 206 and 208 are configured to have a width that gradually decreases from a top surface 210. In some embodiments, an angle (A2) defined between a center axis and a sloped side of the slot ranges from about 1 degree to about 5 degrees. In other embodiments, the angle (A2) is about 3 degrees.

FIG. 10 illustrates an example of the second compartment divider panel 136.

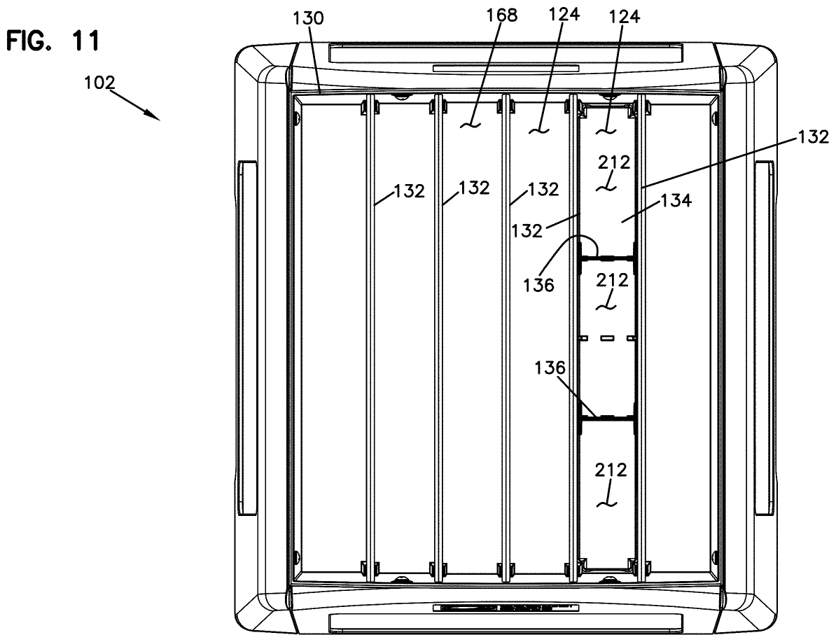

The second compartment divider panel 136 is supported on the compartment spacer 134 to define a plurality of sub-compartments 212 (FIG. 11) within a compartment 124 defined by adjacent first compartment divider panels 132. The sub-compartments 212 are used to store printed materials of smaller sizes.

The second compartment divider panel 136 includes a dividing plate 214 and a panel mounting structure 216.

The dividing plate 214 is arranged transversely within a compartment 124 defined by adjacent first compartment divider panels 132 within the storage body 130.

The panel mounting structure 216 is used to mount the second compartment divider panel 136 on the compartment spacer 134 between the adjacent first compartment divider panels 132. The panel mounting structure 216 can be configured to engage the compartment divider panel mounting structure 202 of the compartment spacer 134. In some embodiments, the panel mounting structure 216 includes one or more tabs 218 configured to be inserted into the slots 204, 206 and 208. The panel mounting structure 216 can further include a buttress portion 220 that supports the second compartment divider panel 136 against the compartment spacer 134 when the tabs 218 are inserted into the slots 204, 206 and 208.

FIG. 11 is a top view of the advertisement deliverable storage system 102, illustrating an example arrangement of the first compartment divider panels 132, the compartment spacer 134, and the second compartment divider panels 136 within the storage body 130. As described herein, the first compartment divider panels 132 divide the cavity 168 of the storage body 130 into multiple compartments 124. The compartment spacer 134 can be disposed within a compartment 124 defined by adjacent first compartment divider panel 132. The second compartment divider panels 136 are supported on the compartment spacer 134 and divide a compartment 124 above the compartment spacer 134 into multiple sub-compartments 212. The second compartment divider panels 136 can be arranged transversely to the first compartment divider panels 132.

Referring to FIGS. 12-16, an example of the control device assembly 140 is described. As described in FIG. 3, the control device assembly 140 includes the control device housing 144 and the control device 146.

In the illustrated example, the control device housing 144 also functions as a base portion of the advertisement deliverable storage system 102 by securing the storage body 130 onto control device housing 144. In other embodiments, the control device assembly 140 is provided as a part separate from a base portion of the advertisement deliverable storage system 102.

FIG. 12 is a perspective view of an example control device housing 144. In some embodiments, the control device housing 144 includes a body 230, a control device receiving portion 232, at least one device charger receiving portion 234, a display device mounting structure 236, a storage body mounting structure 238, and a security lock device 240.

In the illustrated example, the body 230 is generally configured as a rectangular frame having four lateral sides (e.g., first, second, third, and fourth lateral sides 242A, 242B, 242C, and 242D), a bottom portion, and a top portion.

The control device receiving portion 232 is used to receive and secure the control device 146 to the body 230. In some embodiments, the control device receiving portion 232 includes a cavity 250 in which the control device 146 is at least partially received.

The control device receiving portion 232 further includes a control device mounting structure 252 configured to mount the control device 146 within the cavity 250. In some embodiments, the control device mounting structure 252 includes a plurality of fastening holes 254 that stand out from a bottom surface of the cavity 250. The standing-out fastening holes 254 can hold the control device 146 at a predetermined height from the bottom surface of the cavity 250. Fasteners 256 (e.g., screws) (FIG. 3) fit into the fastening holes 254 to fix the control device 146.

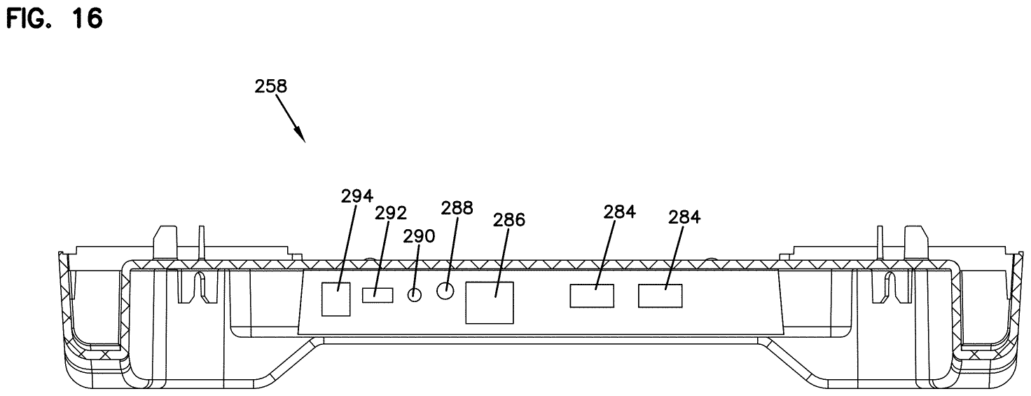

The control device receiving portion 232 defines a plurality of outlet holes 258 configured to expose various ports, cords, and/or switches of the control device 146 therethrough. An example of the outlet holes 258 is described and illustrated in more detail with reference to FIG. 16.

The device charger receiving portion 234 is used to mount a device power charger 296 (FIG. 3) to the body 230. In some embodiments, the device charger receiving portion 234 includes a flange 262 on which the device power charger 296 is placed, and one or more fastener holes 264 through which fasteners 257 (FIG. 3), such as screws, are inserted to fix the device power charger 296 onto the flange 262. In the illustrated example, the device charger receiving portion 234 is provided on the second and fourth lateral sides 242B and 242D of the body 230. The device power charger 296 can be electrically connected to the control device 146 through a cable 297 (FIG. 3). The cable 297 is used to supply power, ground, and control signals to the device power charger 296. In some embodiments, the cable 297 is 10-pin flat flexible cable.

The display device mounting structure 236 is configured to at least partially mount the display device assembly 142 to the advertisement deliverable storage system 102. In some embodiments, the display device mounting structure 236 cooperates with the fastening holes 164 of the side walls 162 of the storage body 130 to attach the display device assembly 142 to the advertisement deliverable storage system 102.

In some embodiments, the display device mounting structure 236 includes at least one display device engaging slots 270 and at least one display device fastening holes 272.

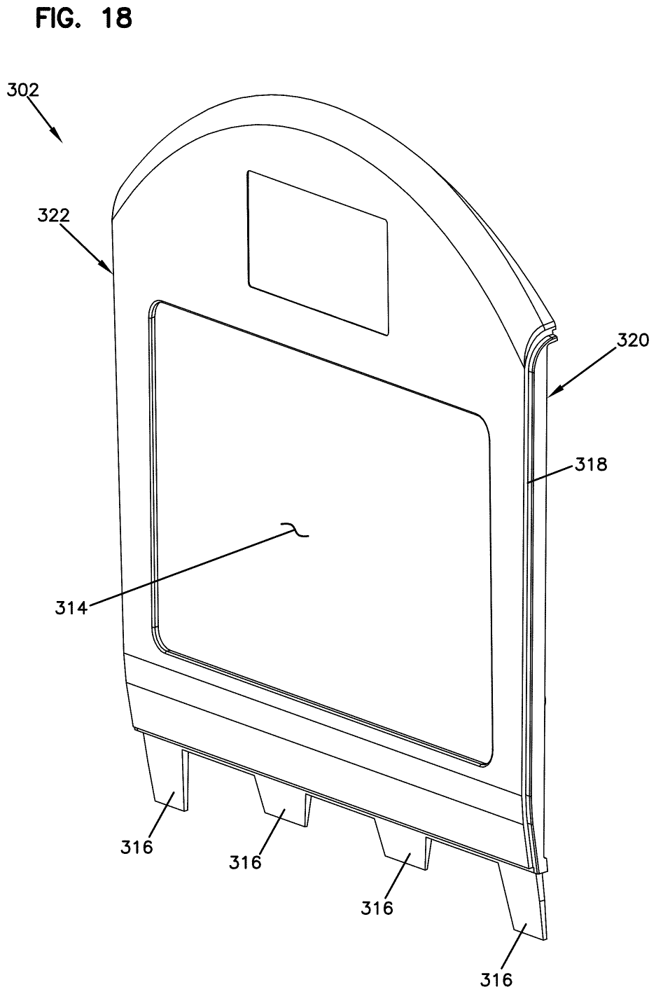

The display device engaging slots 270 are configured to receive engaging tabs 316 (FIG. 18) of the first display device assembly 150 to secure the first display device assembly 150 to the side walls (e.g., the first and third side walls 162A and 162C) of the storage body 130 while the first display device assembly 150 is fastened by the fasteners 166 through the fastening holes 164 of the side walls 162A and 162C.

The display device fastening holes 272 are configured to engage the second display device assembly 152 to secure the second display device assembly 152 to the side walls (e.g., the second and fourth side walls 162B and 162D) of the storage body 130 while the second display device assembly 152 is fastened by the fasteners 166 through the fastening holes 164 of the side walls 162B and 162D.

The storage body mounting structure 238 is used to mount the storage body 130 on the top of the body 230 of the control device housing 144. In some embodiments, the storage body mounting structure 238 includes one or more fastening holes 274 into which the fasteners 184 fit from the bottom of the body 230. The fasteners 184 passing through the fastening holes 274 of the body 230 engage the fastener holes 182 of the storage body 130.

The security lock device 240 provides a structure for locking the advertisement deliverable storage system 102 to any fixture for security purposes. In some embodiments, the security lock device 240 is configured as a slot to which a security anchor attaches. The security anchor has a cable that anchors to any place or object, such as a desk, table, or any fixed surface. An example of the security lock device 240 is a Kensington™ security slot, available from ACCO Brands (Lake Zurich, Ill.).

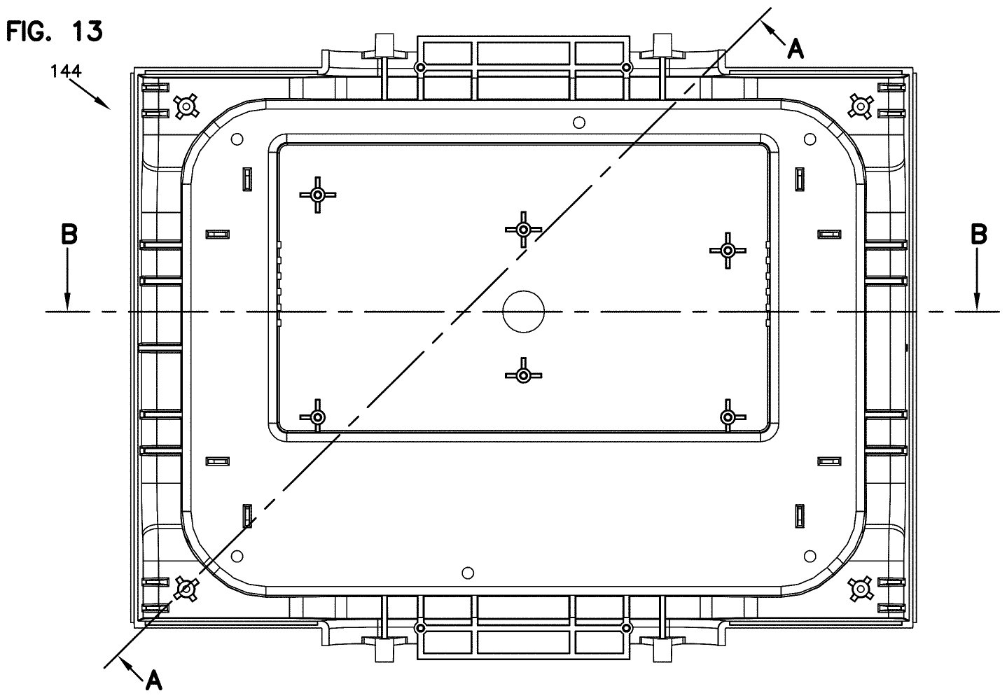

FIG. 13 is a top view of the control device housing 144. The elements of the control device housing 144 that are described with reference to FIG. 12 are also shown in FIG. 13.

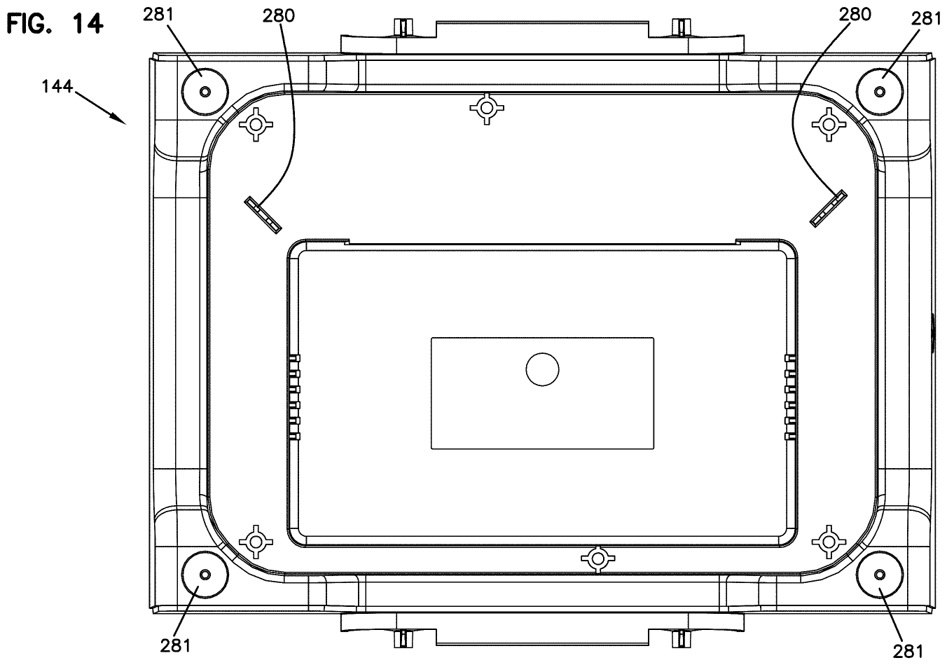

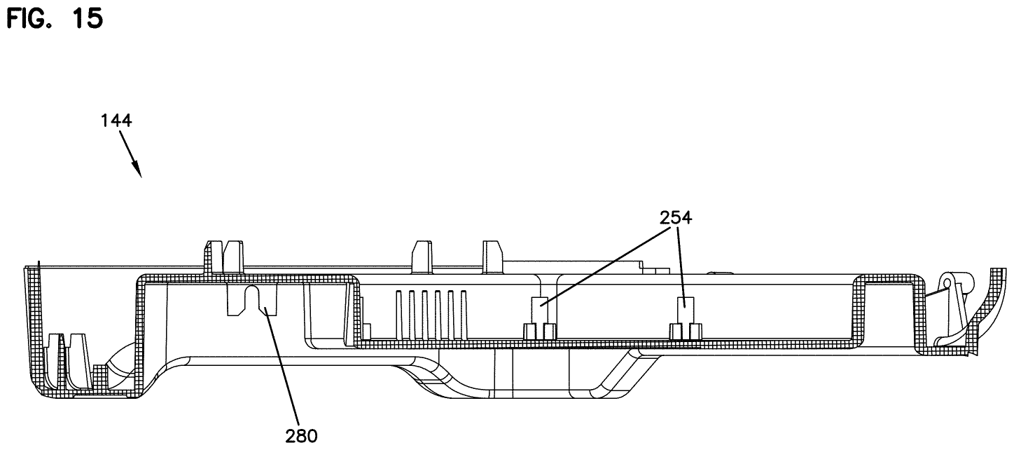

FIG. 14 is a bottom view of the control device housing 144. The elements of the control device housing 144 that are described with reference to FIG. 12 are also shown in FIG. 14. In addition, some embodiments of the control device housing 144 include a cord holding device 280 configured to hold a cord on the bottom portion of the control device housing 144. An example cord holding device 280 is illustrated and described in more detail with reference to FIG. 15.

In some embodiments, the control device housing 144 includes support bumpers or feet 281 (see also FIG. 3). The support feet 281 are attached (e.g., fastened by fasteners, such as screws) to the bottom of the control device housing 144 to support the control device housing 144 against the ground or surface on which the control device housing 144 stands. The support feet 281 are configured to provide traction and shock absorbing qualities to the storage system 102. In some embodiments, the support feet 281 are made of rubber. One example of the support device 281 is part number SF6T-TPR87-B, available from Budwig (San Diego, Calif.).

FIG. 15 is a cross-sectional view of the control device housing 144, taken along line A-A in FIG. 13. In some embodiments, the control device housing 144 includes the cord holding device 280 configured to hold a cord under the control device housing 144 for routing. For example, the cord holding device 280 holds at least portion of a power cord routing from the control device 146 placed within the control device receiving portion 232 of the control device housing 144. In some embodiments, the cord holding device 280 is configured to have two flexible legs that can clamp a cord therebetween.

FIG. 16 is a cross-sectional view of the control device housing 144, taken along line B-B in FIG. 13, to illustrate an example of the outlet holes 258 of the control device receiving portion 232 of the control device housing 144.

In some embodiments, the control device receiving portion 232 defines one or more USB port holes 284, an Ethernet hole 286, an audio jack hole 288, a setup button hole 290, a power switch hole 292, a power inlet hole 294. The USB port hole 284 is an opening through which a USB port provided in the control device 146 is exposed. The Ethernet hole 286 is an opening through which an Ethernet port of the control device 146 is exposed. The audio jack hole 288 is an opening through which an audio jack of the control device 146 is exposed. The setup button hole 290 is an opening through which a setup button of the control device 146 is exposed. The power switch hole 292 is an opening through which a power button (e.g., an ON/OFF switch) is exposed. The power inlet hole 294 is an opening through which a power inlet, such as a coaxial DC power jack, of the control device 146 is exposed.

In other embodiments, the control device receiving portion 232 includes only one or some of the holes 284, 286, 288, 290, 292, and 294. In yet other embodiments, the control device receiving portion 232 includes other holes for different purposes in the same or different arrangement.

Referring again to FIG. 3, the control device 146 is configured to receive the advertising data 112 and output a signal to the display devices 126 to present at least one advertisement content thereon. The control device 146 can also generate data about advertising results or status. In some embodiments, the control device 146 is configured with a printed circuit board with various electronic components. Example configuration and operation of the control device 146 are illustrated and described in more detail with reference to FIGS. 23-26.

In some embodiments, the control device 146 is mounted into the control device receiving portion 232 of the control device housing 144 by the fasteners 256. In some embodiments, the control device 146 includes one or more device power chargers 296 that provide one or more charging ports, such as USB ports.

Referring to FIGS. 17-19, an example of the first display device assembly 150 is described.

FIG. 17 is a perspective expanded view of an example first display device assembly 150. In some embodiments, the first display device assembly 150 includes a display screen frame 302, a display screen 304, a gasket 306, a bracket 308, and fasteners 310.

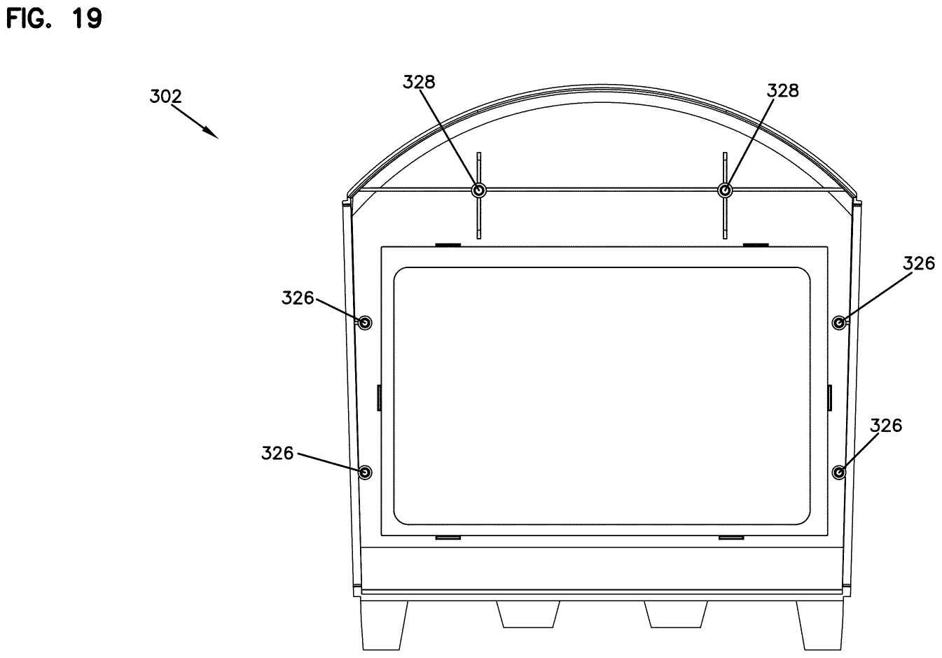

The display screen frame 302 is configured to hold the display screen 304 and attach the display screen 304 to the storage body 130. An example of the display screen frame 302 is illustrated and described in more detail with reference to FIGS. 18 and 19.

The display screen 304 is an output device for presentation of information in visual or tactile form. In some embodiments, the display screen 304 is an electronic visual display, such as flat panel displays. For example, the display screen 304 can be a liquid crystal display (LCD), a plasma display panel (PDP), a light-emitting diode display (LED), electroluminescent display (ELD), electronic paper, Organic light-emitting diode display (OLED), interferometric modular display (IMOD), and other displays suitable for the advertisement deliverable storage system 102. The display screen 304 can have various resolutions, such as 1280×800 pixel array, 1920×1080 pixel array, 1366×768 pixel array, and other display resolution suitable for advertising on the storage system 102.

In some embodiments, the display screen 304 is electrically connected to the control device 146 through a cable 311 (FIG. 3). The cable 311 is used to supply power and transmit data signals to the display screen 304. One example of the cable 311 is a 40-pin flat flexible cable. The cable 311 is sized in length and arranged such that ends of the cable line up with a connector of the display screen 304 and a connector of the control device 146, respectively. Where the connector of the control device is lined up directly under the connector of the display screen, the cable 311 is arranged straight between the connectors of the control device and the display screen. Where the connectors of the display screen and the control device are not lined up, the cable 311 can be folded one or more times between the connectors of the control device and the display screen.

The gasket 306 is provided on the back of the display screen 304, opposite to the display screen frame 302. In some embodiments, the gasket 306 provides a mechanical seal between the first display device assembly 150 (in particular, the display screen 304) and the storage body 130 to prevent damages to the display screen 304.

The bracket 308 is disposed behind the gasket 306 opposite to the display screen frame 302 and the display screen 304 to secure the display screen 304 to the display screen frame 302 by the fasteners 310. Further, the bracket 308 is configured to have cutaway sections 312 that function as cushions to protect the display screen 304 from the force of impact.

The fasteners 310 are used to mount the bracket 308, the display screen 304, and the gasket 306 to the back of the display screen frame 302.

FIG. 18 is a perspective view of an example display screen frame 302 of the first display device assembly 150. In some embodiments, the display screen frame 302 includes a screen opening 314, one or more engaging tabs 316, and side locking tabs 318.

The screen opening 314 is configured to expose the display screen 304.

The engaging tabs 316 extend from a bottom side of the display screen frame 302 and are configured to be inserted into the display device engaging slots 270 of the control device housing 144, in order to secure the first display device assembly 150 to the side walls (e.g., the first and third side walls 162A and 162C) of the storage body 130. For example, the engaging tabs 316 of the first display device assembly 150 are first inserted into the display device engaging slots 270 of the control device housing 144, and the first display device assembly 150 is then fastened by the fasteners 166 through the fastening holes 164 of the side walls 162A and 162C.

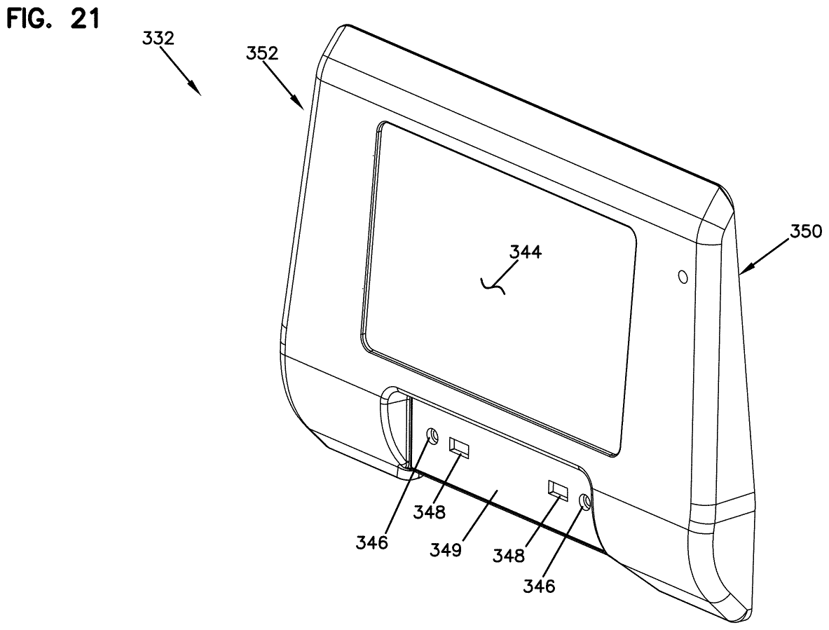

The side locking tabs 318 extend from opposite lateral sides 320 and 322 and engage lateral sides of the second display device assembly 152 (e.g., a display screen frame 332 (FIG. 21) of the second display device assembly 152) as the first and second display device assemblies 150 and 152 are attached to the storage body 130. In some embodiments, the side locking tabs 318 are completely covered by the lateral sides of the second display assembly 152 when the first and second display device assemblies 150 and 152 are attached to the storage body 130.

FIG. 19 is a rear view of the display screen frame 302 of FIG. 18. As illustrated, the display screen frame 302 includes one or more bracket mounting holes 326 and one or more storage body fastening holes 328.

The bracket mounting holes 326 are configured to engage the fasteners 310 passing through holes 330 of the bracket 308, thereby securing the bracket 308, the display screen 304, and the gasket 306 to the display screen frame 302.

The storage body fastening holes 328 are aligned with the fastening holes 164 of the side walls 162A and 164C of the storage body 130 and configured to engage the fasteners 166 passing through the side walls 162A and 164C, thereby securing the first display device assembly 150 to the storage body 130.

Referring to FIGS. 20-22, an example of the second display device assembly 152 is described.

FIG. 20 is a perspective expanded view of an example second display device assembly 152. In some embodiments, the second display device assembly 152 includes a display screen frame 332, a display screen 334, a gasket 336, a bracket 338, and fasteners 340.

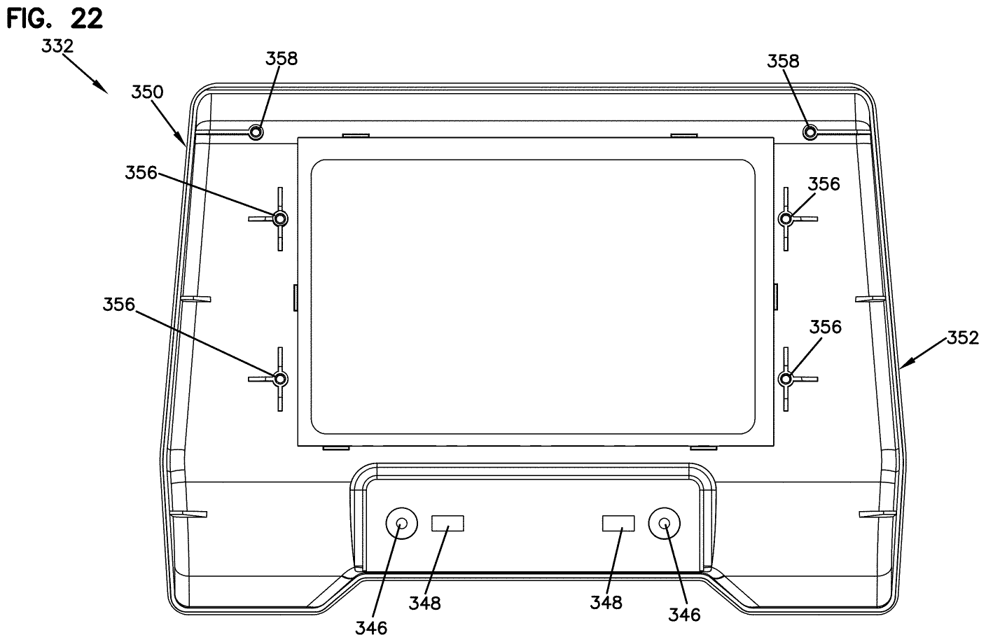

The display screen frame 332 is configured to hold the display screen 334 and attach the display screen 334 to the storage body 130. An example of the display screen frame 332 is illustrated and described in more detail with reference to FIGS. 21 and 22.

The display screen 334 is an output device for presentation of information in visual or tactile form. In some embodiments, the display screen 334 is an electronic visual display, such as flat panel displays. For example, the display screen 334 can be a liquid crystal display (LCD), a plasma display panel (PDP), a light-emitting diode display (LED), electroluminescent display (ELD), electronic paper, Organic light-emitting diode display (OLED), interferometric modular display (IMOD), and other displays suitable for the advertisement deliverable storage system 102. The display screen 334 can have various resolutions, such as 1280×800 pixel array, 1920×1080 pixel array, 1366×768 pixel array, and other display resolution suitable for advertising on the storage system 102.

In some embodiments, the display screen 334 is electrically connected to the control device 146 through a cable 341 (FIG. 3). The cable 341 is similar to the cable 311, and thus the description of the cable 341 is omitted for brevity purposes.

The gasket 336 is provided on the back of the display screen 334, opposite to the display screen frame 332. In some embodiments, the gasket 336 provides a mechanical seal between the second display device assembly 152 (in particular, the display screen 334) and the storage body 130 to prevent damages to the display screen 334.

The bracket 338 is disposed behind the gasket 336 opposite to the display screen frame 332 and the display screen 334 to secure the display screen 334 to the display screen frame 332 by the fasteners 340. Further, the bracket 338 is configured to have cutaway sections 342 that function as cushions to protect the display screen 334 from the force of impact.

The fasteners 340 are used to mount the bracket 338, the display screen 334, and the gasket 336 to the back of the display screen frame 332.

FIG. 21 is a perspective view of an example display screen frame 332 of the second display device assembly 152. In some embodiments, the display screen frame 332 includes a screen opening 344, one or more fastening holes 346, one or more charger holes 348, and side covering portions 350 and 352.

The screen opening 344 is configured to expose the display screen 334.

The fastening holes 346 are provided at a lower portion of the display screen frame 332 and are configured to align the display device fastening holes 272 of the control device housing 144 so that fasteners 354 (FIG. 3) are inserted to the display device fastening holes 272 through the fastening holes 346 of the display screen frame 332, thereby securing the second display device assembly 152 to the side walls (e.g., the second and fourth side walls 162B and 162D) of the storage body 130. For example, the second display device assembly 152 is attached to the side walls 162B and 162D of the storage body 130 by the fasteners 354 inserted into the display device fastening holes 272 of the control device housing 144 through the fastening holes 346 of the display screen frame 332, as well as by the fasteners 166 that secures the display screen frame 332 to the side walls 162B and 162D of the storage body 130.

The charger holes 348 are aligned with the charging ports (e.g., USB ports) provided by the device power chargers 296 of the control device 146 when the second display device assembly 152 is attached to the storage body 130. In the illustrated example, each device power charger 296 includes two USB charging ports and is placed behind the display screen frame 332. Thus, the display screen frame 332 has two charger holes 348.

The side covering portions 350 and 352 are configured to engage the lateral sides 320 and 322 of the display screen frame 302 of the first display device assembly 150, and cover the side locking tabs 318 as the first and second display device assemblies 150 and 152 are attached to the storage body 130. The side locking tabs 318 can operate as a guide feature to assist engaging the second display device assembly 152 with the first display device assembly 150.

In some embodiments, the display screen frame 332 provides a label attaching portion 349 on which a printed overlay 351 (FIG. 3) is attached. As illustrated, the label attaching portion 349 is located around the fastening holes 346 and the charger holes 348 on the display screen frame 332. When attached on the label attaching portion 349, the overlay 351 is configured to cover the fasteners used to mount the second display device assembly 152 to the storage system 102 in place, as well as provide labels for the charging ports provided through the charger holes 348.

FIG. 22 is a rear view of the display screen frame 332 of FIG. 21. As illustrated, the display screen frame 332 includes one or more bracket mounting holes 356 and one or more storage body fastening holes 358.

The bracket mounting holes 356 are configured to engage the fasteners 340 passing through holes 360 of the bracket 338, thereby securing the bracket 338, the display screen 334, and the gasket 336 to the display screen frame 332.

The storage body fastening holes 358 are aligned with the fastening holes 164 of the side walls 162B and 162D of the storage body 130 and configured to engage the fasteners 166 passing through the side walls 162B and 164D, thereby securing the second display device assembly 152 to the storage body 130.

Referring to FIGS. 23-26, an example of the control device 146 is described.

FIG. 23 illustrates an example of the control device 146. In some embodiments, the control device 146 includes a control module 600, a video splitter 602, an input/output interface 604, a device charge controller 606, a power controller 608, and a network interface 610.

The control module 600 operates to receive advertisement data 112 and transmit the advertisement data 112 to display screens 304 and 334. As described herein, the advertisement data 112 include advertisement contents (e.g., videos and still images) and advertising campaign information. An example structure of the control module 600 is described and illustrated in FIG. 25.

The video splitter 602 is a device that takes one signal from a video source and replicates it over a plurality of display screens. The video splitter 602 receives the advertisement data 112 from the control module 600 and transmits the data to a plurality of display screens (e.g., the display screens 304 and 334). In this example, the video splitter 602 generates a plurality of signals that are representative of the advertisement data 112. The signals are transmitted to a plurality of display screens and used to display advertisement contents on the display screens, respectively. In some embodiments, the video splitter 602 generates four identical copies of the data for four display screens 304 and 334.

In other embodiments, the video splitter 602 receives the advertisement data 112 including a plurality of advertisement contents from the control module 600, and generates different sets of advertisements contents for different display screens 304 and 334. For example, the control module 600 and the video splitter 602 are configured to transmit one or more first advertisement contents to at least one of the display screens 304 and 334, and transmit one or more second advertisement contents to the other display screens 304 and 334.

The input/output interface 604 is used to receive input through one or more input devices 612. In some embodiments, a user provides inputs to the control device 146 through the input devices 612. Examples of the input devices 612 include a keyboard 614, a mouse 616, a microphone 618, a touch sensor 620 (such as a touchpad or touch sensitive display) and a portable storage device 612 (such as portable hard drives and flash memory drives or cards). Other embodiments include other input devices 612. The input devices 612 are often connected to the control module 600 through the input/output interface 604. The input devices 612 can be connected by any number of input/output interfaces, such as a parallel port, serial port, game port, or a universal serial bus. Wireless communication between input devices 612 and the interface 604 is possible as well, and includes infrared, BLUETOOTH® wireless technology, 802.11a/b/g/n, cellular, or other radio frequency communication systems in some possible embodiments.

The power controller 608 is configured to deliver power from a power supply 622 to electronic components in the control device 146 as required by the components of the control device 146. In this example, the power supply 622 is an external supply, such as household power supply. In some embodiments, the power controller 608 includes a voltage regulator configured to automatically maintain a constant voltage level to the components of the control device 146. The voltage regulator can regulate one or more AC or DC voltages.

The device charge controller 606 is configured to supply power to a device connected to the device charge controller 606 through charging ports 624 (e.g., USB charging ports). The device charge controller 606 can control a current limiting power switch. In some embodiments, the device charge controller 606 is used to implement the device power charger 296. The device power charger 296 includes one or more charging ports 624, such as USB ports, to deliver power to devices connected to the charging ports. In some embodiments, the device charge controller 606 can monitor port data line voltage and automatically provide correct electrical signatures on the data lines to charge compliant devices. In other embodiments, the device charger controller 606 is designed to detect a device connected thereto through a charging port and confirm a voltage required by the device before starting charging. The device charger controller 606 can be configured to provide about 5 V for a USB port and a current of up to 2 A.

The network interface 610 allows the control device 146 to communicate with the advertisement management server computing device 108. For example, when used in a local area networking environment or a wide area networking environment (such as the Internet), the control device 146 is typically connected to the network 110 through the network interface 610, such as an Ethernet interface. Other possible embodiments use other communication devices. For example, some embodiments of the control module 600 include a modem for communicating across the network.

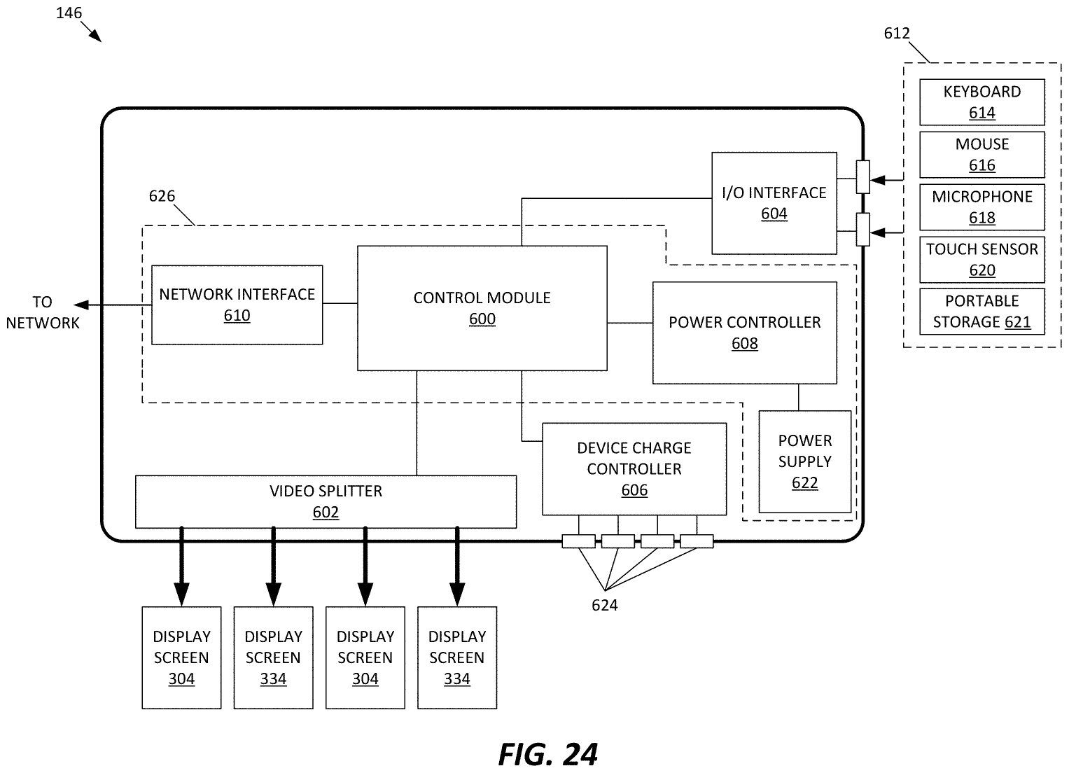

FIG. 24 illustrates another example of the control device 146. The control device 146 in this example is configured similarly to the control device 146 in FIG. 23, except that the power supply 622 is incorporated within the control device 146.

In some embodiments, the power supply 622 is a battery pack that is removable from the control device 146 and rechargeable. In other embodiments, the power supply 622 and one or more of the other components of the control device 146 are made as a module 626 that is removable from the control device 146. For example, the module 626 includes the control module 600, the power controller 608, the network interface 610, and the power supply 622, and is configured to be removable for charging the power supply 622 and for data communication to the network 110.

FIG. 25 illustrates an exemplary architecture of the control module 600.

The control module 600 includes, in some embodiments, at least one processing device 640, such as a central processing unit (CPU). A variety of processing devices are available from a variety of manufacturers, for example, Intel or Advanced Micro Devices. In this example, the control module 600 also includes a system memory 642, and a system bus 644 that couples various system components including the system memory 642 to the processing device 640. The system bus 644 is one of any number of types of bus structures including a memory bus, or memory controller; a peripheral bus; and a local bus using any of a variety of bus architectures.

The system memory 642 includes read only memory 646 and random access memory 648. A basic input/output system 650 containing the basic routines that act to transfer information within the control module 600, such as during start up, is typically stored in the read only memory 646.

The control module 600 also includes a secondary storage device 652 in some embodiments, such as a hard disk drive, for storing digital data. The secondary storage device 652 is connected to the system bus 644 by a secondary storage interface 654. The secondary storage devices 652 and their associated computer readable media provide nonvolatile storage of computer readable instructions (including application programs and program modules), data structures, and other data for the control module 600.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in the secondary storage device 652 or the memory 642, including an operating system 656, one or more application programs 658, other program modules 670 (such as the software engines described herein), and program data 672. The control module 600 can utilize any suitable operating system, such as Linux™, Microsoft Windows™, Google Chrome™, Apple OS, and any other operating system suitable for a computing device.

The display devices 304 and 334 are connected to the system bus 644 via an interface, such as a video adapter 674. In addition to the display devices 304 and 334, the control module 600 can include various other peripheral devices (not shown), such as speakers or a printer.

The control module 600 typically includes at least some form of computer readable media. Computer readable media includes any available media that can be accessed by the control module 600. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the control module 600. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

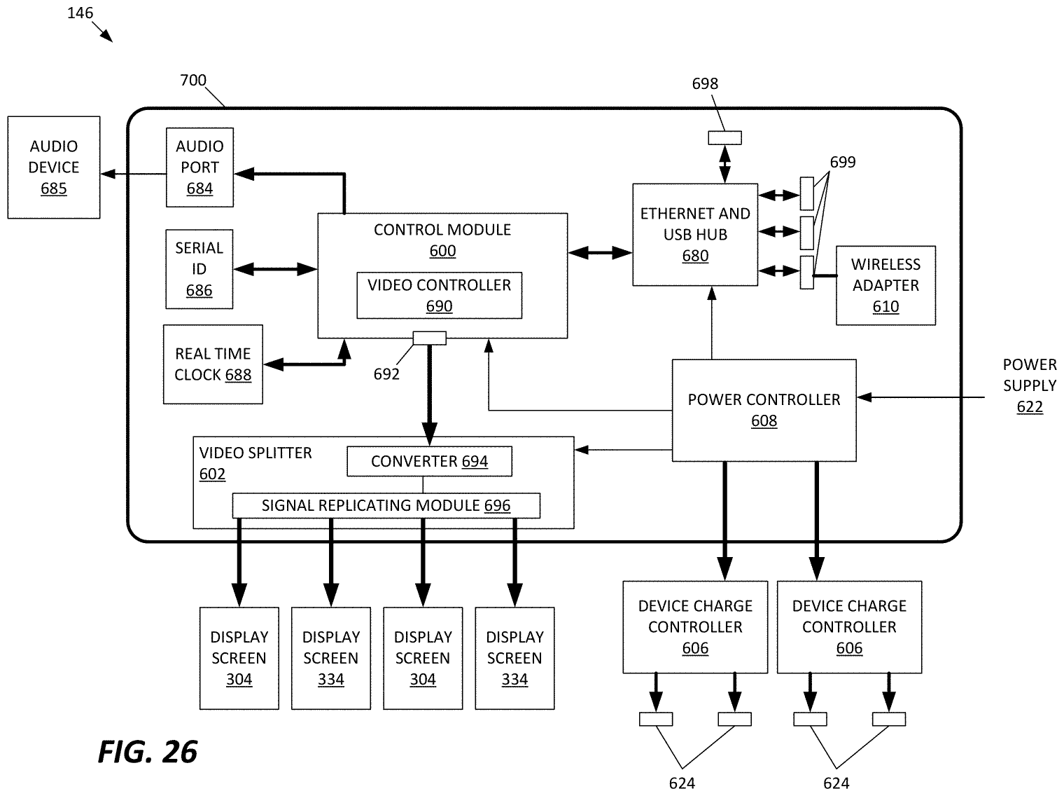

FIG. 26 illustrates yet another example of the control device 146. In some embodiments, the control device 146 includes the control module 600, the video splitter 602, the device charge controller 606 (e.g., USB charge controller), and the power controller 608 (e.g., voltage regulator), which are described herein. The control device 146 further includes an Ethernet and USB hub 680.

In some embodiments, the control module 600 is a Raspberry Pi compute module of various types, available from Raspberry Pi Foundation (United Kingdom). The control module 600 can have an audio port 684 through a pin (e.g., a general purpose input/output pin (GPIO)) on the control module 600. The audio port 684 can be arranged at the audio jack hole 288 (FIG. 16). The audio port 684 is configured to connect an external audio output device 685 (e.g., one or more speakers), thereby outputting an audio of the advertisement contents through the audio output device. For example, such an audio output device has an audio jack configured to be plugged into the audio port 684. In other embodiments, the storage system 102 includes an audio output device, along with the display screens 304 and 344. The control module 600 further attaches a serial ID chip 686 and a real time clock 688 with, for example, I2C interfaces.

The serial ID 686 is used to identify each storage system 102. In some embodiments, the serial ID 686 of a storage system 102 includes its location information or other information associated with that storage system 102 and the consumer interaction area 104 to which the storage system 102 belongs. In some embodiments, such information can be provided by a person or company that manages the storage system 102, such as the advertiser 106.

The real time clock 688 is used to identify the date and time when the advertisement contents are displayed on the storage system 102. The real time clock 688 and/or the serial ID 686 are used to generate feedback data (e.g., status information) in the storage system 102, which are transmitted from the storage system 102 to the server computing device 108.

In some embodiments, the control module 600 includes a built-in video controller 690 to output video contents to the video splitter 602 through, for example, a video port 692 provided to the control module 600. Examples of the video port 692 include a HDMI port and a DVI port.

In some embodiments, the video splitter 602 includes a converter 694 for converting the video signal (e.g., HDMI signal or DVI signal), which is received from the control module 600, to red-green-blue (RGB) digital video data carried over a low-voltage differential signaling (LVDS) bus. In some embodiments, such a conversion is accomplished by creating a bridge using an HDMI receiver. One example receiver is part number TFP401A, available from Text Instruments Inc. (Dallas, Tex.). The HDMI receiver IC is configured to receive the HDMI video data, which is encoded and transmitted across three transition-minimized differential signaling (TMDS) pairs and a clock pair. The video output from the control module is configured to produce proper timings, resolution, and refresh rate for particular screens that are used. When this is accomplished, the output from the HDMI receiver IC will be in a proper format (e.g., RGB LVDS) to directly drive the display screens. As described below, to drive multiple screens with the same content, the LVDS signals are replicated using dedicated ICs (e.g., a signal replicating module 696) designed to repeat LVDS signals.

The video splitter 602 can also include a signal replicating module 696 for generating a plurality of copies of the video signal, which are transmitted to a plurality of video displays 304 and 334, respectively. In this situation, the video contents presented on the video displays 304 and 334 are identical. One example of the signal replicate module 696 is part number SN65LVDS109, available from Texas Instruments Inc. (Dallas, Tex.).

The Ethernet and USB hub 680 operates as both an Ethernet hub for computer networking and a USB hub for connecting various USB devices. The Ethernet and USB hub 680 provides an Ethernet port 698 for connecting an Ethernet device, and one or more USB ports 699. In some embodiments, the USB ports 699 can be used to connect various input devices, such as a keyboard and a mouse, to set up and manage the control device 146. One of the USB ports 699 can be allotted to connect a wireless adapter (e.g., a Wi-Fi dongle) that operates as the network interface 610 for wirelessly communicating to the network. The Ethernet and USB hub 680 can be connected to the control module 600 via serial communication.

In some embodiments, at least some of the components of the control device 146 can be integrated into a single video driver board 700. The video driver board 700 can be configured as a printed circuit board. For example, the video driver board 700 includes the control module 600 including the audio port 684, the serial ID 686, and the real time clock 688, the video splitter 602 including ports associated with the video displays 304 and 334, the voltage regulator 608 including ports associated with the device charger controllers 606, and the Ethernet and USB hub 680 including the Ethernet port 698 and the USB ports 699.

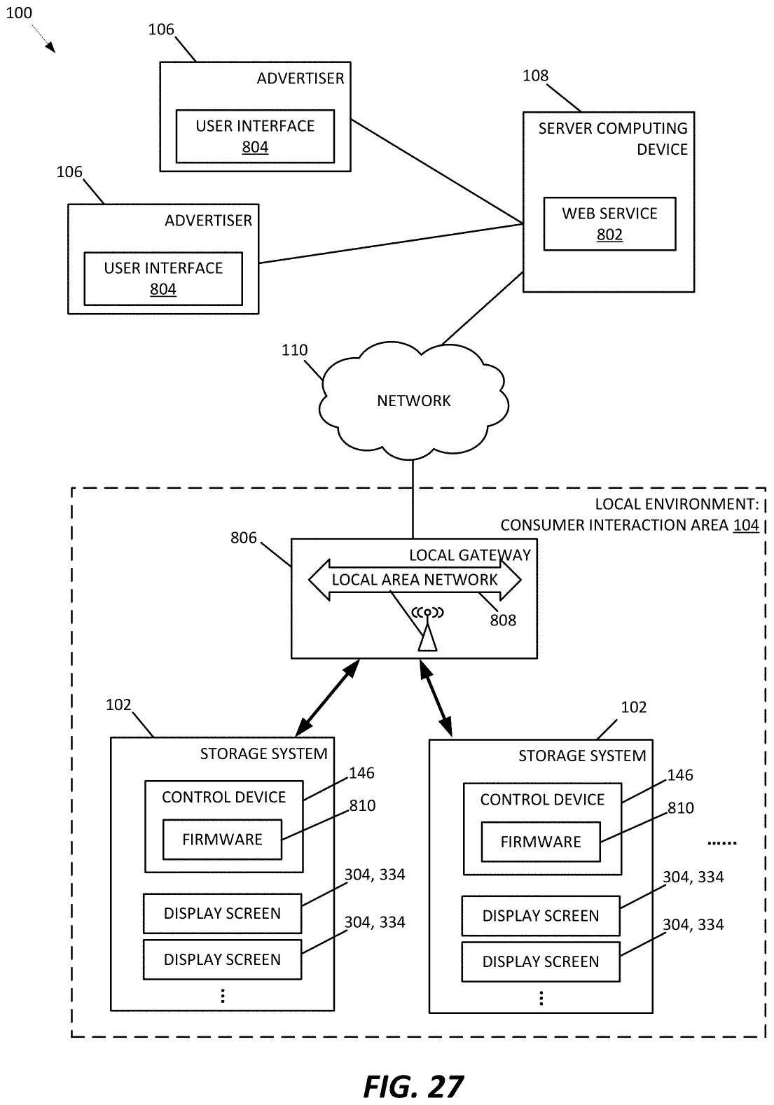

Referring to FIGS. 27-31, an example method of operating the advertisement deliverable storage system 102 is described.

FIG. 27 illustrates the system 100 for operating the advertisement deliverable storage system 102 in more detail. As described in FIG. 1, some embodiments of the system 100 include one or more advertisement deliverable storage systems 102, which are used in one or more consumer interaction areas 104, the advertiser 106, the advertisement management server computing device 108, and the data communication network 110.

In some embodiments, the advertisement management server computing device 108 provides a web service 802 configured to allow the advertiser 106 to communicate data between the advertiser 106 and the server computing device 108, and between the server computing device 108 and the storage systems 102, over a network. The web service 802 can allow programmatic access to data using standard Internet protocols, such as HyperText Transfer Protocol (HTTP). One example of the web service 802 is available from Amazon Web Services, Inc.

In some embodiments, the advertiser 106 uses a user interface 804, such as a web interface, to access the web service 802 provided by the server computing device 108.

The storage systems 102 that are placed in local environment (e.g., the consumer interaction area 104) can be connected to the network 110 through a local gateway 806. The local gateway 806 is a device that provides access to the server computing device 108 through the network 110. In some embodiments, the local gateway 806 generates a secure wireless local area network 808 and connects that wireless local area network 808 to the network 110. In some embodiments, the local gateway 806 is a wireless router.

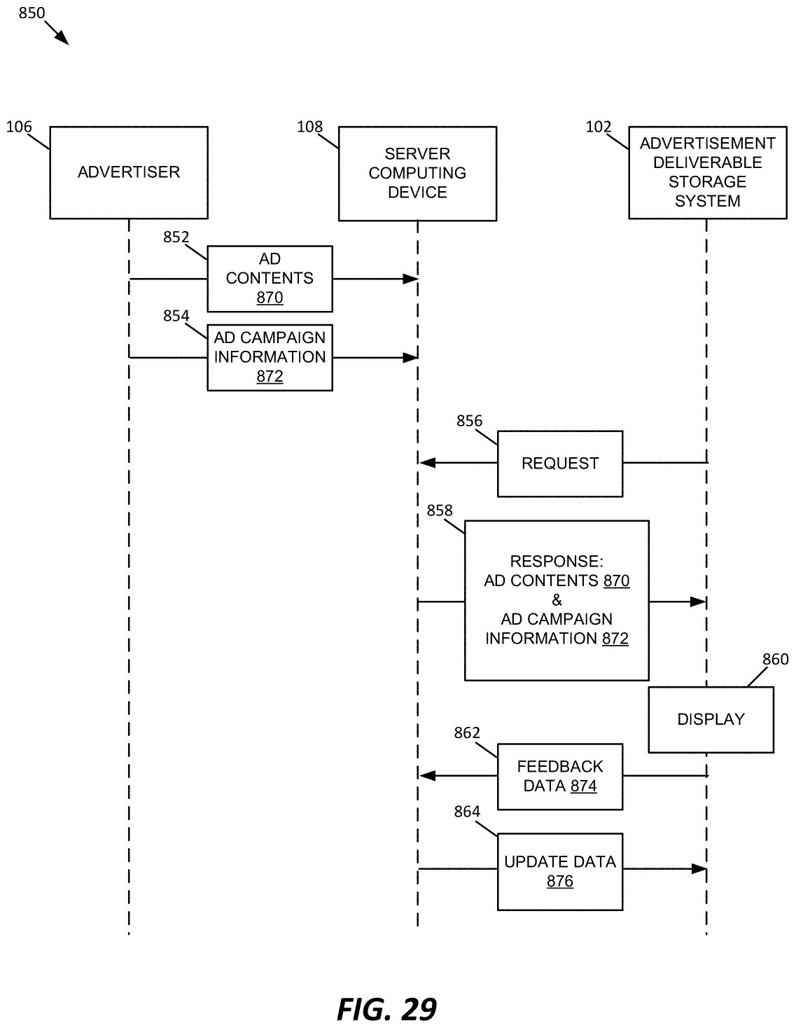

As described herein, the storage system 102 includes one or more display screens 304 and 334 and the control device 146 for displaying advertisement contents on the display screens 304 and 334. In some embodiments, the control device 146 includes firmware 810 held in a memory device, such as the system memory 642. The firmware 810 is designed to access the server computing device 108 to receive advertisement contents 870 and advertising campaign information 872 (FIG. 29) therefrom. The firmware 810 is also configured to transmit data (e.g., feedback data 874 in FIG. 29) from the storage system 102 to the server computing device 108. As described below, some embodiments of the firmware 810 can be preset as the storage system 102 is manufactured. Other embodiments of the firmware 810 are configurable during a setup process for the storage system 102.

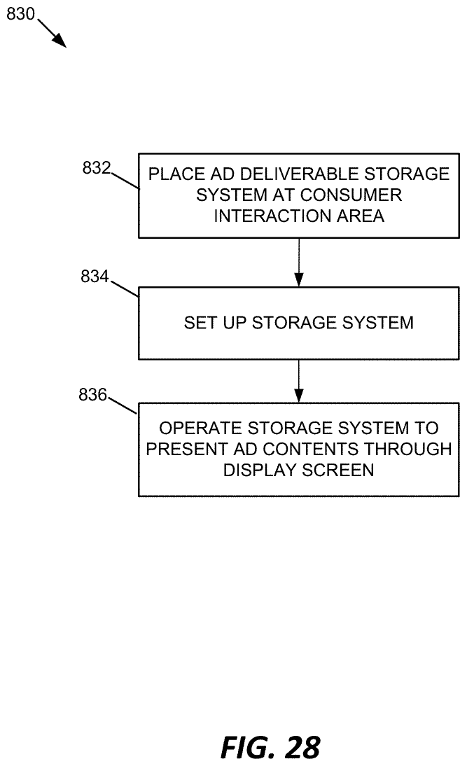

FIG. 28 is a flowchart illustrating an example method 830 for operating the advertisement deliverable storage system 102. In some embodiments, the method 830 includes operations 832, 834, and 836.

At the operation 832, the advertisement deliverable storage system 102 is placed at a predetermined place (e.g., on or adjacent a table or counter) in the consumer interaction area 104, such as office receptions, lobbies, entryways, waiting rooms, and showrooms.

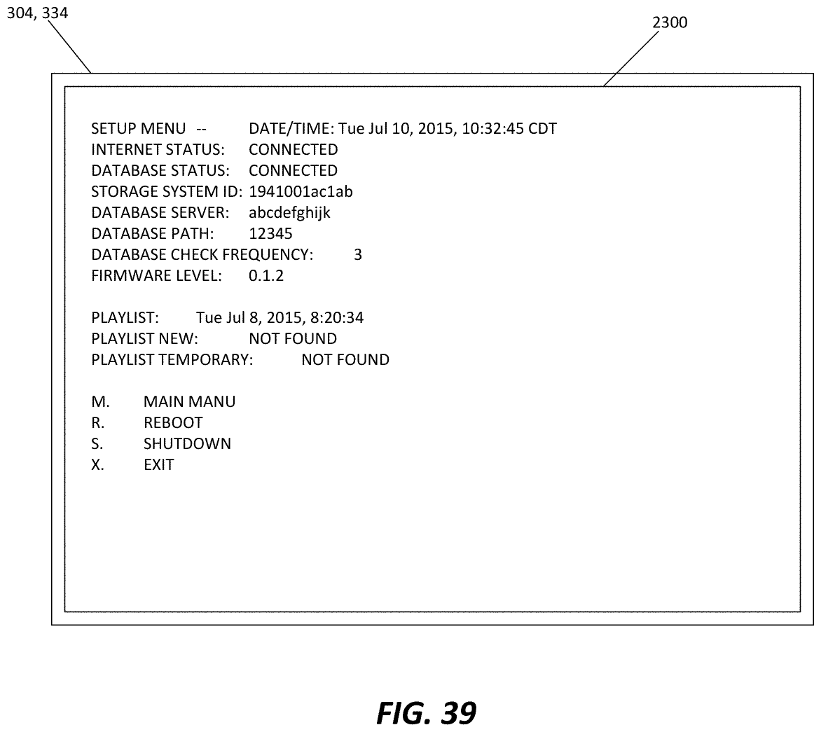

At the operation 834, the advertisement deliverable storage system 102 is set up to configure the control device 146 (e.g., the firmware 810 therein) as necessary. In some embodiments, one or more input devices, such as a keyboard and a mouse, are connected to the control device 146 through the input/output interface 604 (e.g., the Ethernet and USB hub 680), and used to provide setup information to the control device 146. In some embodiments, the control device 146 operates to display a setup interface on at least one of the display screen 304 and 334. The setup interface can be a text based prompt mode configured to receive input for setup. The setup interface can also be a graphic interface. The setup information can include information used to enable the control device 146 to access the server computing device 108, such as a wireless network name (SSID) and password to the local gateway 806 and a uniform resource locator (URL) to the server computing device 108. In other embodiments, the advertisement deliverable storage system 102 is configured to be automatically set up. An example setup interface is described and illustrated in more detail with reference to FIGS. 39-45.

At the operation 836, the advertisement deliverable storage system 102 is operated to receive advertisement contents and advertising campaign information from the server computing device 108 and display the advertisement contents on the display screen 304 and 334 of the advertisement deliverable storage system 102 in accordance with an advertising plan included in the advertising campaign information.

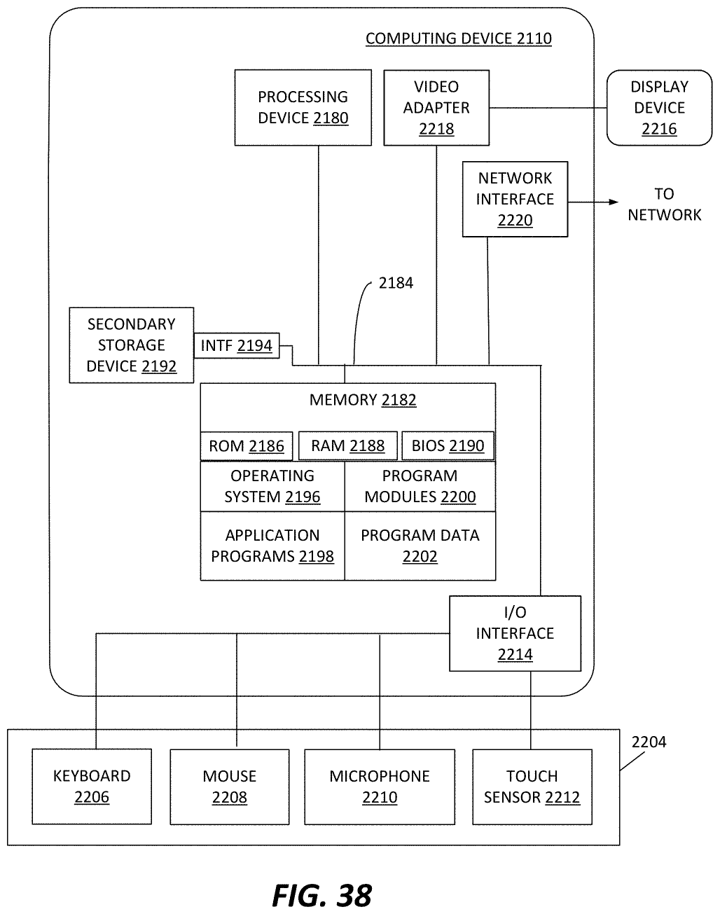

FIG. 29 illustrates an example method 850 of operating the advertisement deliverable storage system 102. In this example, the method 850 includes operations 852, 854, 856, 858, 860, 862, and 864. The method 850 includes operations that are performed by one or more processors (such as the processing device 640 and 2180, as depicted in FIGS. 25 and 38).

At the operation 852, the advertiser 106 transmits (or uploads) advertisement contents 870 to the advertisement management server computing device 108. The advertisement contents 870 are videos, images, audios, and/or other media contents created for an advertising campaign performed by the advertiser 106.

At the operation 854, the advertiser 106 transmits (or uploads) advertising campaign information 872 to the advertisement management server computing device 108. The advertising campaign information 872 is information used to run the advertisement contents on the storage system 102. In some embodiments, the advertising campaign information 872 includes a set of rules that provides conditions for displaying advertisement contents 870. For example, the advertising campaign information 872 includes date and time when advertisement contents are displayed, a frequency at which advertisement contents are displayed, an order or sequence in which a plurality of advertisement contents are displayed, which storage system runs a particular advertisement content, what advertisement contents are run on a particular storage system, what advertisement contents are run at a particular consumer interaction area, and/or one or more locations to advertise.

In other embodiments, instead of via a network, the advertisement contents 870 and the advertising campaign information 872 are physically delivered to an operator or business operating the advertisement management server computing device 108 so that the operator or business stores the advertisement contents 870 and the advertising campaign information 872 in the advertisement management server computing device 108.

At the operation 856, the advertisement deliverable storage system 102 sends a request to the advertisement management server computing device 108 to obtain the advertisement contents 870 and the advertising campaign information 872. In some embodiments, the request includes information identifying the advertisement deliverable storage system 102, such as the information from the serial ID 686

In some embodiments, the advertisement deliverable storage system 102 periodically checks with the advertisement management server computing device 108 for new or other advertisement contents 870 and the advertising campaign information 872 by periodically sending the request to the advertisement management server computing device 108. In some embodiments, the schedule and other conditions of sending the request is at least partially configurable.

At the operation 858, the advertisement management server computing device 108 responds to the request from the advertisement deliverable storage system 102 by sending the advertisement contents 870 and the advertising campaign information 872.

At the operation 860, the storage system 102 operates to display at least one of the advertisement contents 870 on at least one of the display screens 304 and 334 in accordance with the advertising campaign information 872.

At the operation 862, the storage system 102 generates feedback data 874. In some embodiments, the storage system 102 sends the feedback data 874 to the advertisement management server computing device 108. The feedback data 874 include advertising status information. The advertising status information includes the status, statistics, or results of displaying the advertisement contents 870. In some embodiments, the feedback data 874 identify how many times an advertisement content 870 is presented on the storage system 102. The feedback data 874 can include information about whether advertisements contents 870 are presented on the storage system 102 as required by the advertising campaign information 872. In other embodiments, the feedback data 874 include information about which advertisement content is displayed on which storage system at what date and time. In yet other embodiments, the feedback data 874 include a total runtime of the advertisement contents 870. In yet other embodiments, the feedback data 874 include other pieces of information about running the advertisement contents 870 on storage systems 102. The feedback data 874 can be used to analyze the status, result, and/or effectiveness (e.g., return on investment) of the advertising campaign by the advertiser 106.

At the operation 864, the advertisement management server computing device 108 transmits update data 876 to the advertisement deliverable storage system 102. The update data 876 are used to update the control device 146 (e.g., the software and/or firmware therein) to improve the operation of the storage system 102. In some embodiments, the update data 876 are periodically transmitted to the storage system 102. In other embodiments, the update data 876 are sent to the storage system 102 as available. In some embodiments, the schedule and other conditions of transmitting the update data 876 is at least partially configurable.

In some embodiments, the update data 876 is transmitted from the advertisement management server computing device 108 in response to a request from the storage system 102.

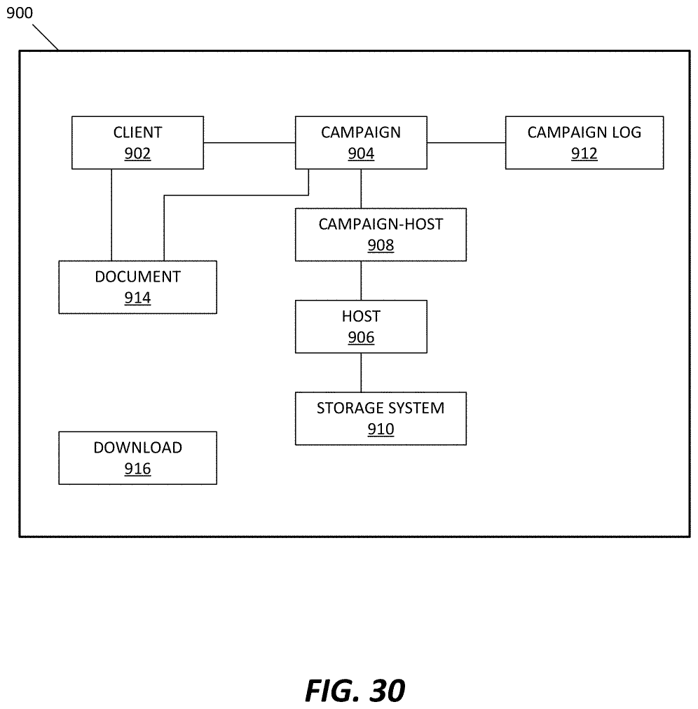

FIG. 30 illustrates an example server database structure 900 that is implemented in the advertisement management server computing device 108. In some embodiments, the server database structure 900 includes a client table 902, a campaign table 904, a host table 906, a campaign-host table 908, a storage system table 910, a campaign log table 912, a document table 914, and a download table 916.

The client table 902 includes a list of advertisers 106 and information associated with the advertisers 106.

The campaign table 904 includes a list of advertising campaigns and information associated with the advertising campaign. In some embodiments, each advertising campaign includes one advertisement content. In other embodiments, each advertising campaign includes a plurality of advertisement contents. Each advertiser 106, which is identified by the client table 902, can be associated with one or more advertising campaigns. In some embodiments, the campaign table 904 is used to define the advertising campaign information 872. For example, the campaign table 904 identifies a start data/time and an end data/time for running each advertising campaign.

The host table 906 includes a list of consumer interaction areas and information associated with the consumer interaction areas. Each consumer interaction area, which is identified by the host table 906, can be associated with one or more advertising campaigns, which are identified by the campaign table 904.

The campaign-host table 908 includes information of matching the advertising campaigns from the campaign table 904 with the consumer interaction areas from the host table 906.

The storage system table 910 includes a list of advertisement deliverable storage systems and information associated with the storage systems.

The campaign log table 912 includes a log of running the advertisement contents on the storage systems. In some embodiments, the campaign log table 912 identifies what advertisement content is displayed on which storage system at what date/time, and how many times a particular advertisement content is presented. The campaign log table 912 can be used to store the feedback data 874 transmitted from the storage systems 102.

The document table 914 includes a list of file locations to advertisement contents, such as videos and images. In some embodiments, the advertisement contents 870 are stored in a remote file store. In this configuration, the document table 914 is used to identify the locations of advertisement contents at the remote file store.

The download table 916 includes a view of the tables contained in the server database 900 of the advertisement management server computing device 108. Computing devices, such as the control device 146 of the storage system 102, can access the tables of the server database 900 through the download table 916.

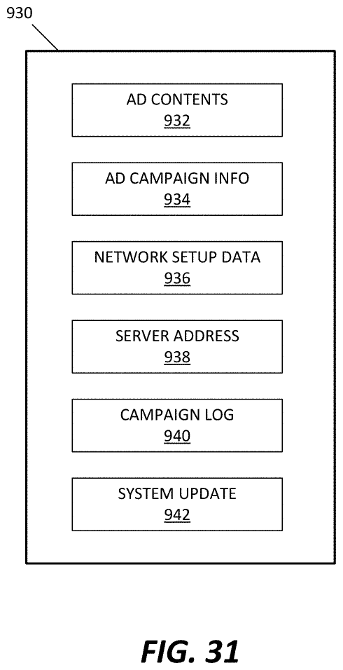

FIG. 31 illustrates an example control device database structure 930 that is implemented in the control device 146 of the advertisement deliverable storage system 102. In some embodiments, the control device database structure 930 includes an advertisement contents table 932, an advertising campaign information table 934, a wireless network setup data table 936, a server address table 938, a campaign log table 940, and a system update table 942.

The advertisement contents table 932 includes a list of advertisement contents, such as videos and images, and is used to identify the advertisement contents.

The advertising campaign information table 934 includes a list of advertising campaigns, as in the campaign table 904. In some embodiments, the advertising campaign information table 934 includes the advertising campaign information 872, which provides conditions for displaying advertisement contents 870.

The wireless network setup data table 936 includes information, such as wireless network name (SSID) and password, for establishing a wireless connection.

The server address table 938 includes information for establishing data communications with server computing device 108, such as a uniform resource locator (URL) to the server computing device 108.

The campaign log table 940 includes the result of running advertisement contents, such as the number of times that an advertisement content runs, on which storage system an advertisement content is presented, when an advertisement content is displayed, and other status of displaying advertisement contents. In some embodiments, the campaign log table 940 is used to generate the feedback data 874.

The system update table 942 includes information about updating the control device 146. For example, the system update table 942 defines how often the storage system 102 sends a request for system update (e.g., for the update data 876).

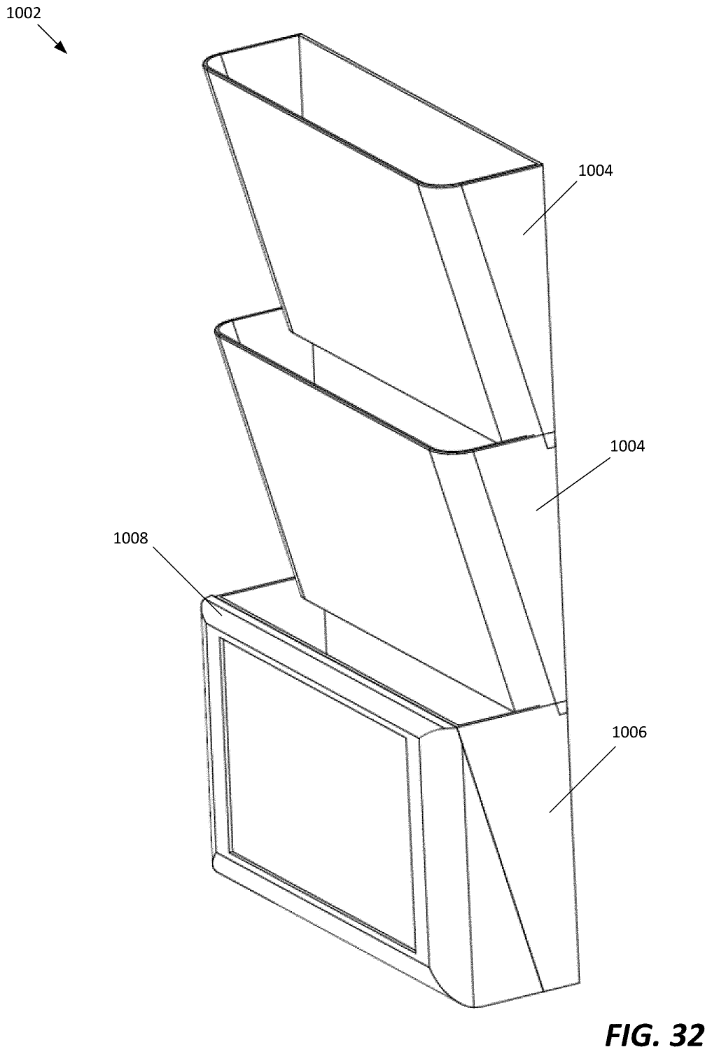

Referring to FIGS. 32-35, another example of the advertisement deliverable storage system 1002 is schematically described. For clarity, some components or parts of the storage system 1002 are simplified or omitted. As many of the concepts and features are similar to the first example shown in FIGS. 2-22, the description for the first example is hereby incorporated by reference for this example. Where like or similar features or elements are shown, the same or similar reference numbers will be used where possible.

FIG. 32 is a schematic perspective view of another example advertisement deliverable storage system 1002. In this example, the storage system 1002 is configured as a wall mount rack. In some embodiments, the storage system 1002 includes at least one first storage unit 1004, at least one second storage unit 1006, and at least one advertisement output assembly 1008.

The first storage unit 1004 is configured to store objects, such as printed materials, and hang against a wall. As illustrated, the first storage units 1004 can be coupled to each other and vertically stack up to provide multiple levels of storage spaces.

The second storage unit 1006 is configured similarly to the first storage unit 1004 except that the second storage unit 1006 is further configured to attach the advertisement output assembly 1008.

The advertisement output assembly 1008 operates to display one or more advertising contents through a display device therein. In some embodiments, the advertisement output assembly 1008 is configured similarly to the advertisement output assembly 122. The advertisement output assembly 1008 is secured to the second storage unit 1006. In the illustrated example, the advertisement output assembly 1008 is fixed on a front face of the second storage unit 1006 while a top side of the second storage unit 1006 is open for receiving objects (e.g., printed materials).

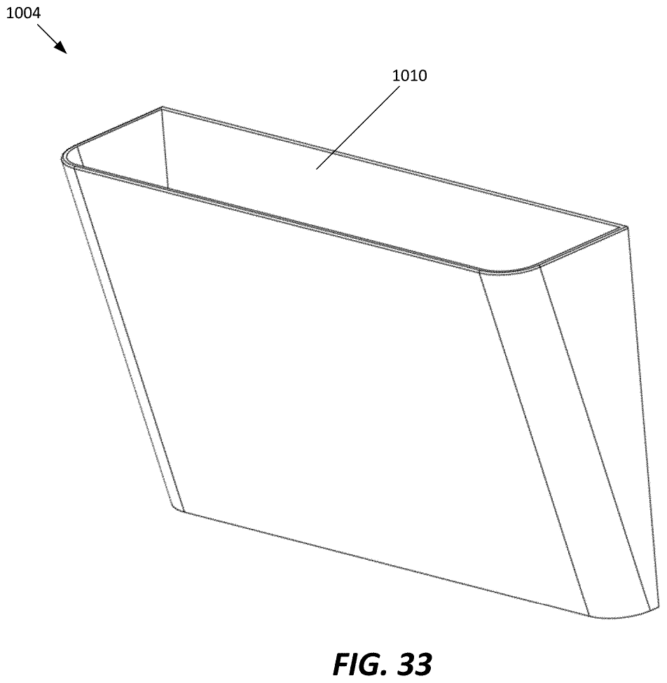

FIG. 33 schematically illustrates an example of the first storage unit 1004. As illustrated, the first storage unit 1004 defines a compartment 1010 for storing objects.

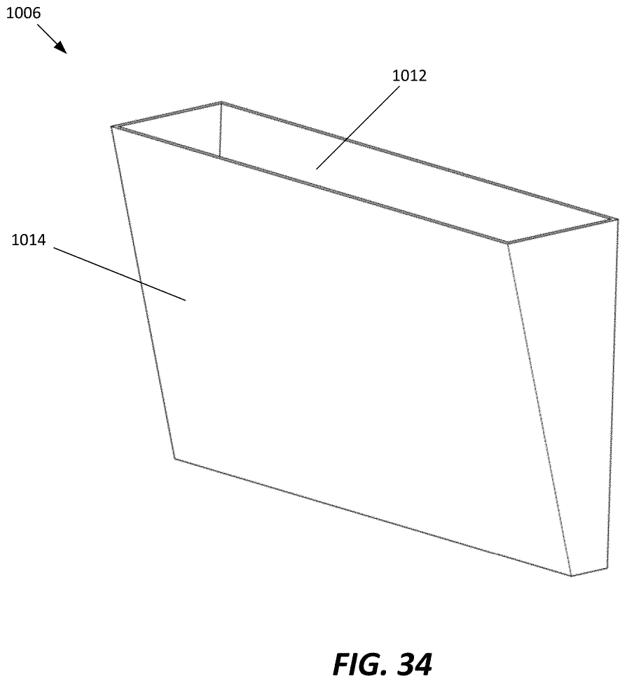

FIG. 34 schematically illustrates an example of the second storage unit 1006. As illustrated, the second storage unit 1006 defines a compartment 1012 for storing objects. The second storage unit 1006 further has a display engaging face 1014 configured to mount the advertisement output assembly 1008.

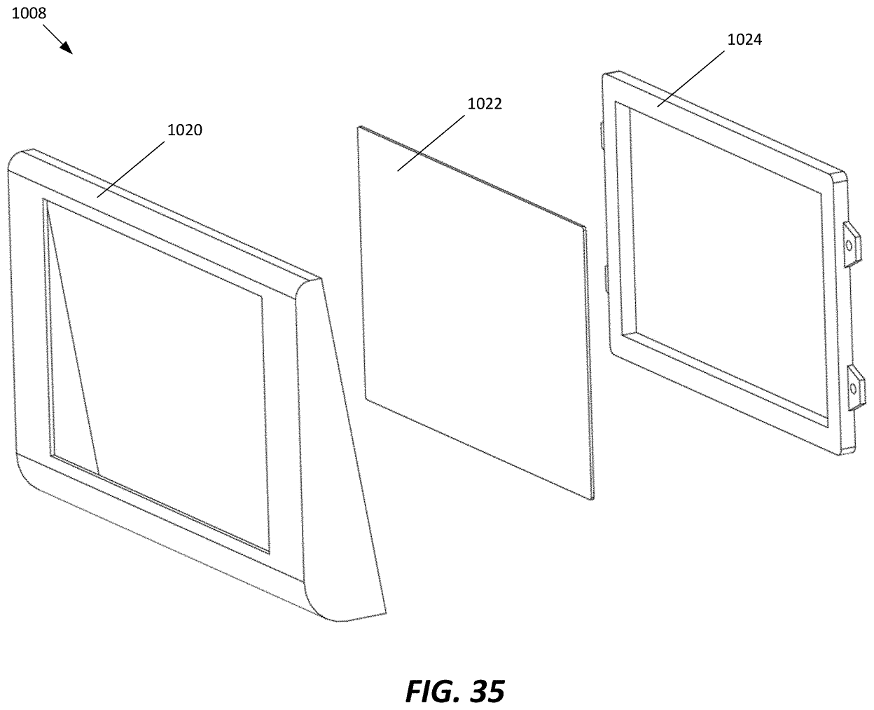

FIG. 35 is a schematic expanded view of an example of the advertisement output assembly 1008. As illustrated, some embodiments of the advertisement output assembly 1008 include a display screen frame 1020, a display screen 1022, and a bracket 1024.

The display screen frame 1020 is configured to hold the display screen 1022 and attach the display screen 1022 to the second storage unit 1006.

The display screen 1022 is an output device for presentation of information in visual or tactile form. In some embodiments, the display screen 1022 is an electronic visual display, such as flat panel displays. For example, the display screen 1022 can be a liquid crystal display (LCD), a plasma display panel (PDP), a light-emitting diode display (LED), electroluminescent display (ELD), electronic paper, Organic light-emitting diode display (OLED), interferometric modular display (IMOD), and other displays suitable for the advertisement deliverable storage system 102. The display screen 1022 can have various resolutions, such as 1280×800 pixel array, 1920×1080 pixel array, 1366×768 pixel array, and other display resolution suitable for advertising on the storage system 1002.

The bracket 1024 is provided on the back of the display screen 1022, opposite to the display screen frame 1020. In some embodiments, the bracket 1024 provides a mechanical seal between the display screen frame 1020 and the second storage unit 1006 to prevent damages to the display screen 1022.

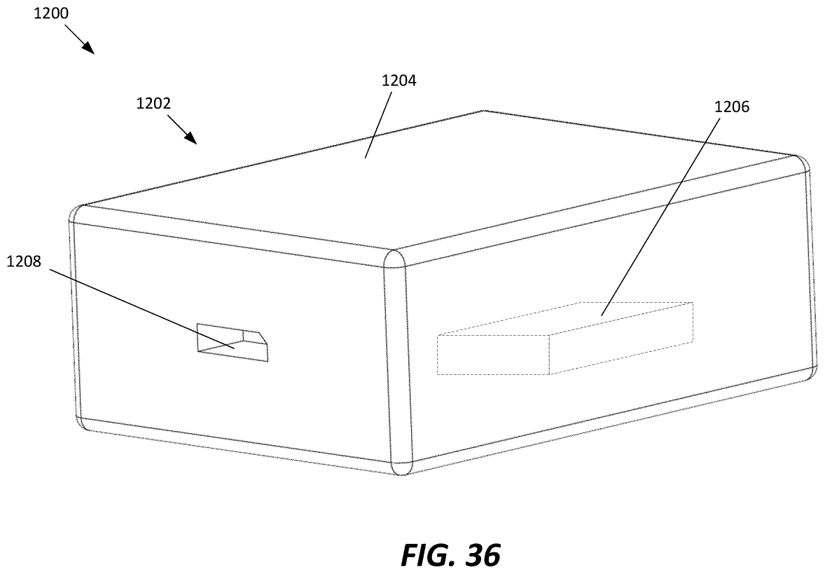

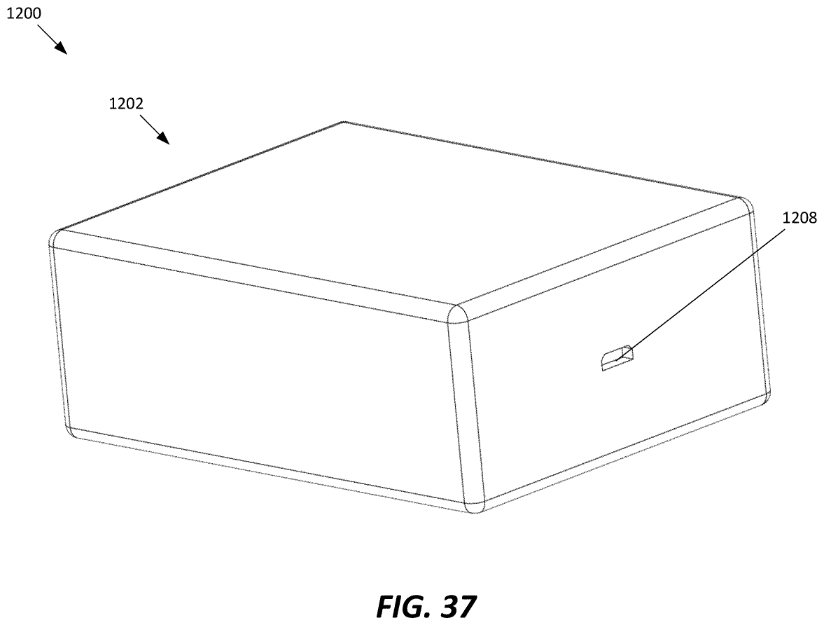

Referring to FIGS. 36 and 37, an example advertisement delivery system 1200 that is used with a storage system is described. In particular, FIG. 36 is a schematic front perspective view of an example advertisement delivery system 1200, and FIG. 37 is a schematic rear perspective view of the advertisement delivery system 1200 of FIG. 36. For clarify, some components or parts of the advertisement delivery system 1200 are simplified or omitted.

In some embodiments, the advertisement delivery system 1200 includes an advertisement output assembly 1202 that is a separate module configured to be connected to a display screen to display advertisement contents on the display screen. The display screen can be associated with a storage unit, such as literature rack for storing printed materials of various types (e.g., books, magazines, brochures, flyers, and other publications).

In some embodiments, the advertisement output assembly 1202 of the advertisement delivery system 1200 includes a body 1204, a control device 1206, a power supply port 1208, and a data output port 1210.

The control device 1206 is included in the body 1204 and configured to store advertising contents and advertising campaign information and run the advertising contents on a connected display screen based on the advertising campaign information. In some embodiments, the control device 1206 is configured similarly to the control device 146.

The power supply port 1208 is defined by the body 1204 and configured to supply power from an external power source.

The data output port 1210 is defined by the body 1204 and configured to output data, such as advertising contents and advertising campaign information, from the control device 1206 within the body 1204.

The advertisement delivery system 1200 operates to incorporate a display screen as a system for advertising. In some embodiments, the advertisement delivery system 1200 is configured to provide advertisement contents only to one display screen to which the advertisement delivery system 1200 is connected.

In some embodiments, a display device to which the advertisement delivery system 1200 is connected is accompanied with a storage unit as described herein. In other embodiments, the advertisement delivery system 1200 is used with a display screen that is not associated with a storage unit.

FIG. 38 illustrates an exemplary architecture of a computing device that can be used to implement aspects of the present disclosure, including any of the plurality of computing devices used by the advertisers 106, the advertisement management server computing device 108, or the advertisement deliverable storage systems 102. The computing device illustrated in FIG. 38 can be used to execute the operating system, application programs, and software modules (including the software engines) described herein. By way of example, the computing device will be described below as the computing device 2110. To avoid undue repetition, this description of the computing device will not be separately repeated herein for each of the other computing devices, including the computing devices used by the advertisers 106, the advertisement management server computing device 108, or the advertisement deliverable storage systems 102, but such devices can also be configured as illustrated and described with reference to FIG. 38.

The computing device 2110 includes, in some embodiments, at least one processing device 2180, such as a central processing unit (CPU). A variety of processing devices are available from a variety of manufacturers, for example, Intel or Advanced Micro Devices. In this example, the computing device 2110 also includes a system memory 2182, and a system bus 2184 that couples various system components including the system memory 2182 to the processing device 2180. The system bus 2184 is one of any number of types of bus structures including a memory bus, or memory controller; a peripheral bus; and a local bus using any of a variety of bus architectures.

Examples of computing devices suitable for the computing device 2110 include a desktop computer, a laptop computer, a tablet computer, a mobile computing device (such as a smart phone, an iPod® or iPad® mobile digital device, or other mobile devices), or other devices configured to process digital instructions.

The system memory 2182 includes read only memory 2186 and random access memory 2188. A basic input/output system 2190 containing the basic routines that act to transfer information within computing device 2110, such as during start up, is typically stored in the read only memory 2186.

The computing device 2110 also includes a secondary storage device 2192 in some embodiments, such as a hard disk drive, for storing digital data. The secondary storage device 2192 is connected to the system bus 2184 by a secondary storage interface 2194. The secondary storage devices 2192 and their associated computer readable media provide nonvolatile storage of computer readable instructions (including application programs and program modules), data structures, and other data for the computing device 2110.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 2192 or memory 2182, including an operating system 2196, one or more application programs 2198, other program modules 2200 (such as the software engines described herein), and program data 2202. The computing device 2110 can utilize any suitable operating system, such as Linux™, Microsoft Windows™, Google Chrome™, Apple OS, and any other operating system suitable for a computing device.

In some embodiments, a user provides inputs to the computing device 2110 through one or more input devices 2204. Examples of input devices 2204 include a keyboard 2206, mouse 2208, microphone 2210, and touch sensor 2212 (such as a touchpad or touch sensitive display). Other embodiments include other input devices 2204. The input devices are often connected to the processing device 2180 through an input/output interface 2214 that is coupled to the system bus 2184. These input devices 2204 can be connected by any number of input/output interfaces, such as a parallel port, serial port, game port, or a universal serial bus. Wireless communication between input devices and the interface 2214 is possible as well, and includes infrared, BLUETOOTH® wireless technology, 802.11a/b/g/n, cellular, or other radio frequency communication systems in some possible embodiments.

In this example embodiment, a display device 2216, such as a monitor, liquid crystal display device, projector, or touch sensitive display device, is also connected to the system bus 2184 via an interface, such as a video adapter 2218. In addition to the display device 2216, the computing device 2110 can include various other peripheral devices (not shown), such as speakers or a printer.

When used in a local area networking environment or a wide area networking environment (such as the Internet), the computing device 2110 is typically connected to the network through a network interface 2220, such as an Ethernet interface. Other possible embodiments use other communication devices. For example, some embodiments of the computing device 2110 include a modem for communicating across the network.

The computing device 2110 typically includes at least some form of computer readable media. Computer readable media includes any available media that can be accessed by the computing device 2110. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 2110. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 38 is also an example of programmable electronics, which may include one or more such computing devices, and when multiple computing devices are included, such computing devices can be coupled together with a suitable data communication network so as to collectively perform the various functions, methods, or operations disclosed herein.

FIGS. 39-45 illustrate an example setup interface 2300 displayed on at least one of the display screens 304 and 334. In the illustrated example, the setup interface 2300 provides a text-based interface that can be interacted through a keyboard.

FIG. 39 shows that the setup interface 2300 displays various pieces of information about the storage system 102 and the server computing device 108. For example, such information includes a network status, a server connection status, a storage system ID, a server computing device ID and path, a frequency setting for communication between the storage system 102 and the server computing device 108, and information about an advertising playlist.

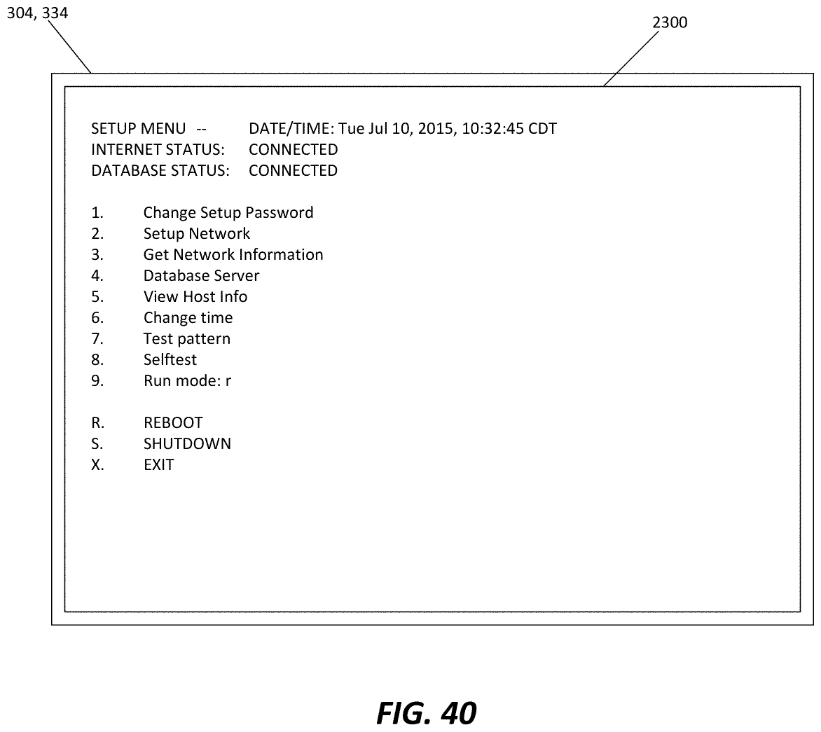

FIG. 40 shows that the setup interface 2300 displays an example menu screen for setup. For example, the menu includes a setup password change, a network setup, a network information management, a database server (e.g., the server computing device 108) management, a host information management, a date/time management, a test pattern setup, a self-testing, and a running mode demonstration or selection.

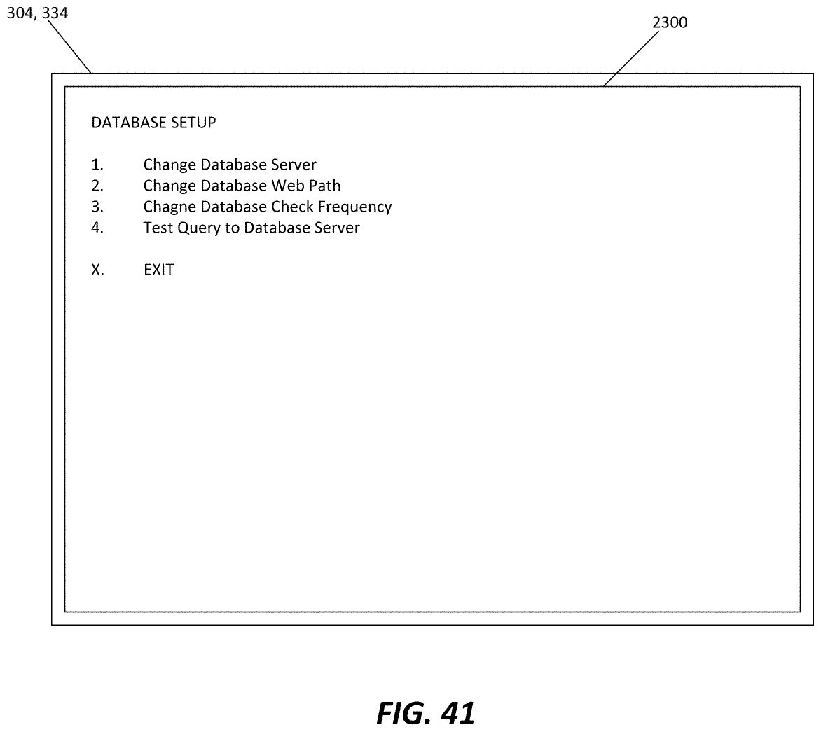

FIG. 41 shows that the setup interface 2300 displays an example database setup screen. For example, the database setup includes a database server change, a database web path change, a database check frequency change, and testing of query to the database server.

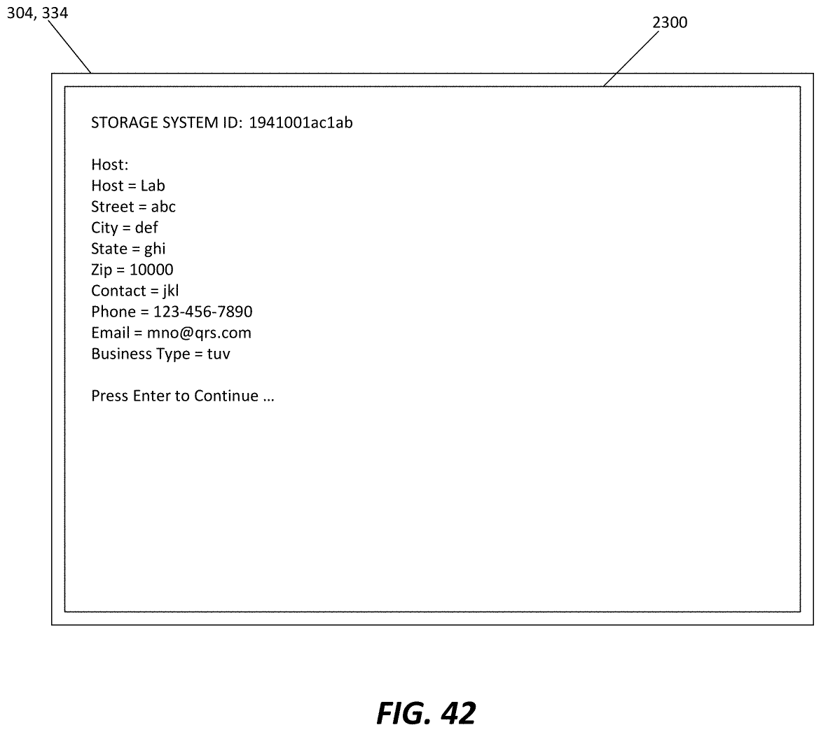

FIG. 42 shows that the setup interface 2300 displays information about the storage system 102.

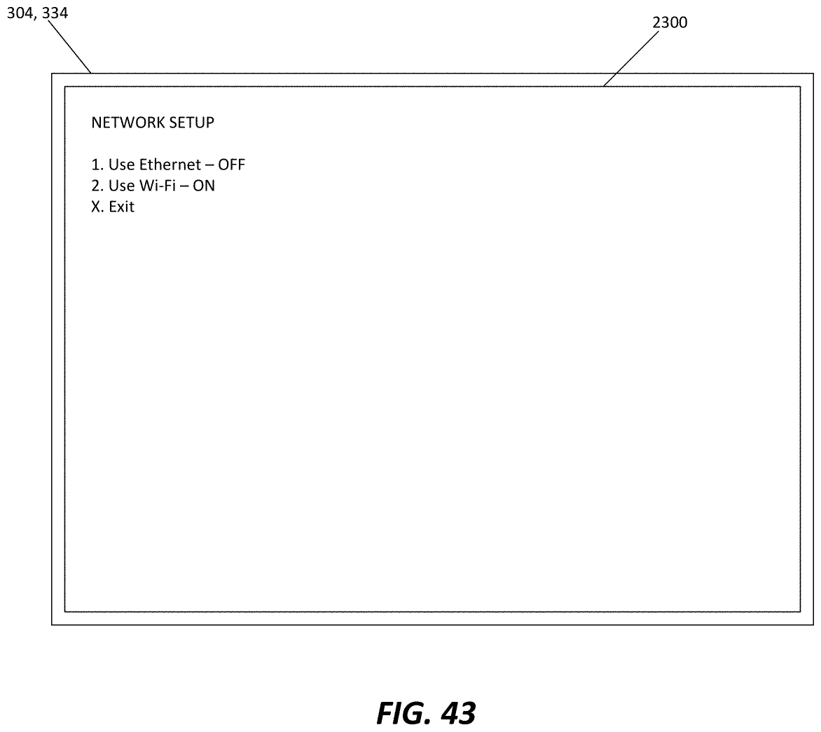

FIG. 43 shows that the setup interface 2300 displays an example screen for a network setup. In the illustrated example, a network can be selected between Ethernet and Wi-Fi.

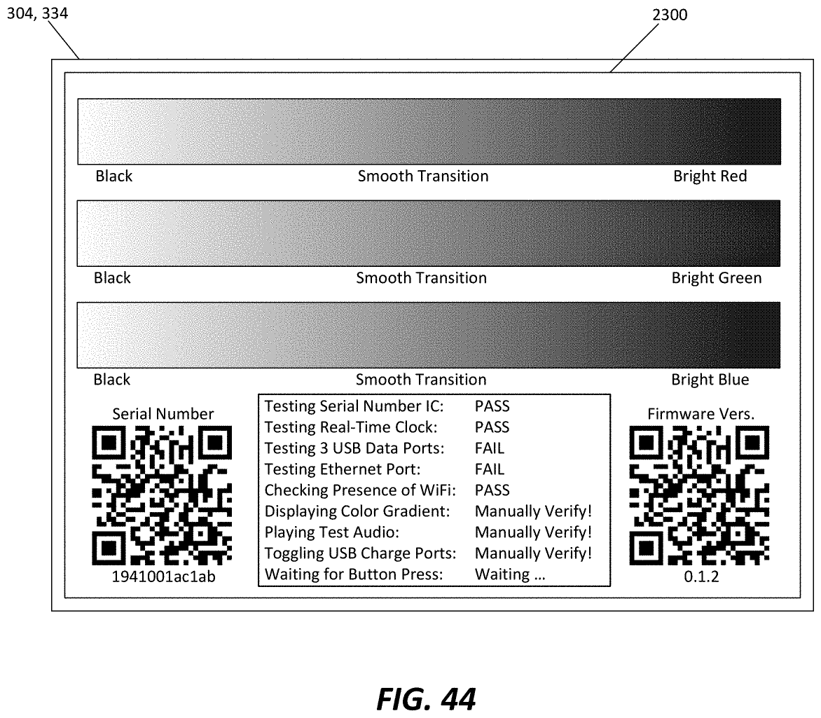

FIG. 44 shows that the setup interface 2300 displays an example self-testing process.

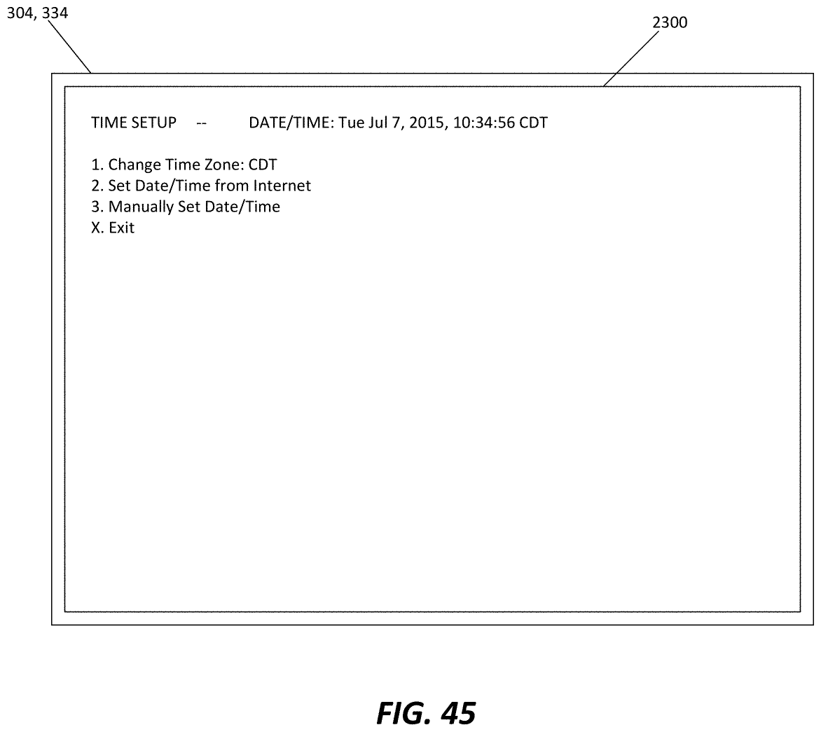

FIG. 45 shows that the setup interface 2300 displays an example screen for a date/time setup.

The various examples and teachings described above are provided by way of illustration only and should not be construed to limit the scope of the present disclosure. Those skilled in the art will readily recognize various modifications and changes that may be made without following the examples and applications illustrated and described herein, and without departing from the true spirit and scope of the present disclosure.

1-20. (canceled)

21. A storage rack for displaying electronic content comprising:
a storage assembly including a storage body having a plurality of side walls and a bottom portion defining a storage cavity;
the storage cavity divided into a plurality of storage compartments defined by at least one dividing panel arranged in the storage cavity;
the storage assembly further including a base portion attached to the bottom portion;
a control device receiving portion integrally formed in the bottom portion;
a control device attached to the control device receiving portion;
the control device including a processing device, a network communication device, a device charge controller, a video splitter, a plurality of video ports, one or more charging ports, and one or more communication ports;
a plurality of electronic displays wherein the electronic displays are attached to each of the side walls, wherein no more than one display is attached to any side wall;
each of the electronic displays configured to display at least one content;
the control device configured to receive the content and transmit it to at least one of the electronic displays;
the video splitter configured to receive content from the control device and split the content amongst the electronic displays such that each of the electronic displays may display the same or different advertisement content;
a power supply electrically attached to the control device to provide power to the control device and the electronic displays;
a plurality of cables coupled between the electronic displays and the control device, each of the cables supplying power and a video signal from the control device to one of the displays; and
the control device receiving portion including a plurality of outlet holes that expose at least one of the video ports, charging ports, and communication ports.

22. The storage rack of claim 21, wherein the content comprises advertising content.

23. The storage rack of claim 21, further including a power controller that delivers power from the power supply to the control device.

24. The storage rack of claim 21, wherein the control device is configured to communicate to a content management server computing device in order to receive the content.

25. The storage rack of claim 21, wherein the control device is configured to receive the content through an input device connected to the storage system.

26. The storage rack of claim 24, wherein the control device is configured to generate feedback data including status information.

27. The storage rack of claim 26, wherein the control device is configured to transmit the feedback data to the content management server computing device.

28. The storage rack of claim 21, wherein the control device is configured to receive update data that updates the control device to improve an operation of the storage system.

29. The storage system of claim 21, wherein the control device includes an audio port configured to connect to an external output device.

30. A storage rack for displaying electronic content comprising:
a storage assembly including a storage body having a plurality of side walls and a bottom portion defining a storage cavity;
the storage cavity divided into a plurality of storage compartments defined by at least one dividing panel arranged in the storage cavity;
the storage assembly further including a base portion attached to the bottom portion;
a control device attached to the bottom portion;
the control device including a processing device, a video splitter, at least one video port, at least one charging port, and at least one communication port;
a plurality of electronic displays wherein the electronic displays are attached to each of the side walls, wherein no more than one display is attached to any side wall;
each of the electronic displays configured to display at least one content;
the control device configured to receive the content and transmit it to at least one of the electronic displays;
the video splitter configured to receive content from the control device and split the content amongst the electronic displays such that each of the electronic displays may display the same or different advertisement content;
a power supply electrically attached to the control device to provide power to the control device and the electronic displays; and
a plurality of cables coupled between the electronic displays and the control device to supply power and videos signal from the control device to the displays.

31. The storage rack of claim 30, wherein the content comprises advertising content.

32. The storage rack of claim 30, further including a power controller that delivers power from the power supply to the control device.

33. The storage rack of claim 30, wherein the control device is configured to communicate to a content management server computing device in order to receive the content.

34. The storage rack of claim 30, wherein the control device is configured to receive the content through an input device connected to the storage system.

35. The storage rack of claim 33, wherein the control device is configured to generate feedback data including status information.

36. The storage rack of claim 34, wherein the control device is configured to transmit the feedback data to the content management server computing device.

37. The storage rack of claim 30, wherein the control device is configured to receive update data that updates the control device to improve an operation of the storage system.

38. The storage system of claim 30, wherein the control device includes an audio port configured to connect to an external output device.

39. An electronic storage rack comprising:
a storage body comprising a bottom and four sidewalls defining an interior cavity having an open top;
at least one compartment divider panel arranged within the cavity to divide the interior cavity into a plurality of compartments accessible through the open top;
a base portion secured to the bottom of the storage body, the base portion including a control device housing and a control device, the control device contained within the control device housing, the control device including a processing device, a network communication device, a power controller, and a video splitter;
four electronic display assemblies, each positioned along and secured to the sidewalls of the storage body and extending upward from the base; and
a plurality of transmission cables coupled between the electronic display device assemblies and the base to deliver power from the power controller to the electronic display device assemblies and display signals from the video splitter to the electronic display device assemblies.
